(19) United States
(12) Patent Application Publication
(10) Pub. No.: US 2025/0308320 A1
(43) Pub. Date: Oct. 2, 2025

(54) DYNAMIC FUNDING OF GAMING ESTABLISHMENT DEVICE IN ASSOCIATION WITH AN EXTERNAL ACCOUNT

(71) Applicant: IGT, Las Vegas, NV (US)

(72) Inventors: Jeffery Shepherd, Reno, NV (US); Kevin Higgins, Reno, NV (US)

(21) Appl. No.: 18/616,572

(22) Filed: Mar. 26, 2024

(51) Int. Cl. G07F 17/32; G06Q 20/12

(52) U.S. Cl. CPC G07F 17/3225; G06Q 20/123; G07F 17/3244

(57) ABSTRACT

Systems and methods that enable a transfer of funds from an external account to a gaming establishment device in which a funding pathway is determined based on one or more attributes of a user associated with the external account.

### BACKGROUND

In various embodiments, the systems and methods of the present disclosure enable a transfer of funds from an external account to a gaming establishment device in which a funding pathway is determined based on one or more attributes of a user associated with the external account.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF SUMMARY

In certain embodiments, the present disclosure relates to a system including a processor, and a memory device that stores a plurality of instructions. When executed by the processor responsive to a receipt of data associated with an approval of an amount of funds transferred from a financial institution account maintained, independent of any gaming establishment, in association with a financial institution, and responsive to a determination that a user associated with the financial institution account is associated with a gaming establishment account maintained by a gaming establishment fund management system, the instructions cause the processor to activate a wagering account transfer funding pathway. In these embodiments, the wagering account transfer funding pathway includes causing a first transfer of the amount of funds to the gaming establishment account, and causing a second transfer of the amount of funds from the gaming establishment account to a balance of a gaming establishment device. When executed by the processor responsive to the receipt of data associated with the approval of the amount of funds transferred from the financial institution account and responsive to a determination that the user associated with the financial institution account is not associated with any gaming establishment accounts maintained by the gaming establishment fund management system, the instructions cause the processor to activate an electronic funds transfer funding pathway. In these embodiments, the activated electronic funds transfer funding pathway includes causing, independent of any wagering account transfers associated with the gaming establishment device, a transfer of the amount of funds to the balance of the gaming establishment device.

In certain embodiments, the present disclosure relates to a system including a processor, and a memory device that stores a plurality of instructions. When executed by the processor responsive to a receipt of data associated with an approval of an amount of funds transferred from a financial institution account maintained, independent of any gaming establishment, in association with a financial institution and responsive to a determination that a user associated with the financial institution account is not associated with any gaming establishment patron management account maintained by a gaming establishment patron management system, the instructions cause the processor to activate an electronic funds transfer funding pathway. In these embodiments, the electronic funds transfer funding pathway includes a direct transfer of the amount of funds to a credit balance of an electronic gaming machine, the direct transfer occurring independent of any gaming establishment account maintained by a gaming establishment fund management system. When executed by the processor responsive to the receipt of data associated with the approval of the amount of funds transferred from the financial institution account, responsive to a determination that the user associated with the financial institution account is associated with a gaming establishment patron management account maintained by the gaming establishment patron management system and responsive to a determination that the user associated with the financial institution account is associated with a gaming establishment account maintained by the gaming establishment fund management system, the instructions cause the processor to activate a wagering account transfer funding pathway. In these embodiments, the wagering account transfer funding pathway includes an indirect transfer of the amount of funds to the credit balance of the electronic gaming machine, the indirect transfer occurring in association with the gaming establishment account maintained by the gaming establishment fund management system.

In certain embodiments, the present disclosure relates to a method of operating a system. Responsive to a receipt of data associated with an approval of an amount of funds transferred from a financial institution account maintained, independent of any gaming establishment, in association with a financial institution and responsive to a determination that a user associated with the financial institution account is associated with a gaming establishment account maintained by a gaming establishment fund management system, the method includes activating, by a processor, a wagering account transfer funding pathway. In these embodiments, the activated wagering account transfer funding pathway includes causing a first transfer of the amount of funds to the gaming establishment account, and causing a second transfer of the amount of funds from the gaming establishment account to a balance of a gaming establishment device. Responsive to the receipt of data associated with the approval of the amount of funds transferred from the financial institution account and responsive to a determination that the user associated with the financial institution account is not associated with any gaming establishment accounts maintained by the gaming establishment fund management system, the method includes activating, by the processor, an electronic funds transfer funding pathway. In these embodiments, the activated electronic funds transfer funding pathway includes causing, independent of any wagering account transfers associated with the gaming establishment device, a transfer of the amount of funds to the balance of the gaming establishment device.

Additional features are described herein, and will be apparent from the following Detailed Description and the figures.

### BRIEF DESCRIPTION OF THE SEVERAL VIEWS OF THE DRAWINGS

FIGS. 1A, 1B and 1C are example configurations of alternative embodiments of the architecture of a plurality of different components of the system of the present disclosure.

FIGS. 2A and 2B are flow charts of example processes for operating a system including determining which funding pathway to employ based on a user being associated with a gaming establishment patron management system account and/or a gaming establishment fund management system account.

FIGS. 3A, 3B and 3C are flow charts of example processes for operating a system including various components that operate to employ a determined funding pathway to transfer funds from an external account maintained by an external funding source to a gaming establishment device.

FIG. 4 is a flow chart of an example process for operating a system including various components that operate to employ a determined funding pathway to transfer funds from an external account maintained by an external funding source to a gaming establishment device independent of any gaming establishment fund management system account associated with any gaming establishment fund management system.

FIG. 5A is a flow chart of an example processes for operating a system including employing multiple channels of data to determine whether to impose any responsible gaming limitations and/or undertake any anti-money laundering actions in association with a transfer of funds from an external account maintained by an external funding source independent of any gaming establishment fund management system account associated with any gaming establishment fund management system.

FIG. 5B is a flow chart of an example processes for operating a system including employing multiple channels of data to determine whether to trigger any bonus events in association with a transfer of funds from an external account maintained by an external funding source independent of any gaming establishment fund management system account associated with any gaming establishment fund management system.

### DETAILED DESCRIPTION

In various embodiments, the systems and methods of the present disclosure enable a transfer of funds from an external account to a gaming establishment device in which a funding pathway is determined based on one or more attributes of a user associated with the external account.

In certain embodiments, in association with the movement of funds from an external account to a gaming establishment device, the system of the present disclosure determines a funding pathway based on one or more attributes of a user associated with the transfer. In these embodiments, if a user associated with a requested transfer of funds from an external account is associated with a first attribute, the system operates to fund the gaming establishment device via a first funding pathway that employs certain gaming establishment components. On the other hand, if a user associated with a requested transfer of funds from an external account is not associated with the first attribute, the system operates to fund the gaming establishment device via a second, different funding pathway that does not employ certain gaming establishment components. Additionally, if a user associated with a requested transfer of funds from an external account is associated with both the first attribute and a second, different attribute, the system determines, based on one or more funding pathway preferences or priorities, which funding pathway to employ and then utilizes that determined funding pathway to fund the gaming establishment device with funds originating from an external account. For example, if a user associated with a requested transfer of funds from an external account to an electronic gaming machine (i.e., a gaming establishment device) is associated with a gaming establishment account, such as a cashless wagering account, maintained by a gaming establishment fund management system, the system operates to fund the electronic gaming machine via a first funding pathway that includes transferring funds from the external account to the gaming establishment account and then transferring funds from the gaming establishment account to the electronic gaming machine. In this example, if a user associated with a requested transfer of funds from an external account to an electronic gaming machine is not associated with a gaming establishment account, the system operates to fund the electronic gaming machine via a second funding pathway that includes transferring funds from the external account to the electronic gaming machine and bypassing any gaming establishment account. Accordingly, since certain funding pathways are preferable over other funding pathways, rather than employ a single funding pathway for all transfers from external accounts to gaming establishment devices, the system of the present disclosure dynamically determines which funding pathways are available for a given transaction and then employs an available funding pathway based on a preferential ranking or order of such available funding pathways. Such a configuration provides more flexibility in how users fund gaming establishment devices and offers a more efficient operation via customizing the funding options for each individual user based on one or more attributes of that individual user.

In certain embodiments, in association with the movement of funds from an external account to a gaming establishment device (and in view of the potential subsequent movement of such funds elsewhere), the system of the present disclosure imposes certain limits, such as responsible gaming limits and/or anti-money laundering limits, potentially not otherwise available. In certain such embodiments, since multiple funding pathways may be available to transfer funds from an external account and certain of such funding pathways include the transfer of funds from an external account that bypasses any gaming establishment account maintained by a gaming establishment fund management system (that otherwise includes capabilities to screen for violations of certain limits), the system operates to track funds transferred over multiple funding pathways. In these embodiments, the system determines if any transactions, individually or collectively, violate one or more imposed limits, and takes zero, one or more appropriate actions accordingly. For example, since the transfer of funds from a financial institution account (i.e., an external account) to an electronic gaming machine (i.e., a gaming establishment device) may occur in association with a cashless wagering account maintained by a cashless wagering system (that may impose funding limits) or independent of any cashless wagering accounts, the system of the present disclosure monitors events occurring in association with at least these multiple funding pathways and enforces transfer limits on a periodic basis to ensure that responsible gaming limits are met and/or the system is not being abused to potentially launder money.

In certain embodiments, in association with the movement of funds from an external account to a gaming establishment device, the system of the present disclosure triggers certain bonuses based on the potential prioritization of certain funding pathways over other funding pathways. In certain such embodiments, since multiple funding pathways may be available to transfer funds from an external account and certain of such funding pathways are preferable over others, such as because such funding pathways pertain to an identified user having a cashless wagering account over an unidentified user (or an identified user without a cashless wagering account) and/or such funding pathways are associated with different fee structures and/or amounts of time to complete, the system operates to potentially offer one or more bonuses in association with certain funding pathways. In these embodiments, the system determines if any transactions, individually or collectively, warrant a bonus event and if so, causes one or more bonus events to occur. For example, in accordance with the priority of different funding pathways that each result in the transfer of funds from a financial institution account (i.e., an external account) to an electronic gaming machine (i.e., a gaming establishment device), the system of the present disclosure monitors events occurring in association with at least these multiple funding pathways, and determines, based on certain bonus criteria (e.g., the funding pathway employed, the amount of the transfer, and/or the time of such a transfer), whether to trigger a bonus event.

Accordingly, certain embodiments of the present disclosure dynamically determine whether to transfer funds from an external account (e.g., a financial institution account) to a credit balance of a gaming establishment device (e.g., an electronic gaming machine) in association with such funds being transferred to a gaming establishment account (and thus enables a gaming establishment increased visibility into transactions involving users) or independent of such funds being transferred to any gaming establishment accounts (and thus saves users time and effort in having to set up such a gaming establishment account as well as save processing resources by reducing the quantity of accounts such funds have to travel to before reaching the destination device). In such embodiments, regardless of the funding pathway dynamically determined to employ, since certain gaming establishment patrons are uncomfortable venturing into a gaming establishment with large amounts of cash, the system enables a user access to an amount of funds transferred from an external account without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via the dynamically determined funding pathway involving a direct or indirect transfer of funds from an external account to a gaming establishment device, the system reduces or eliminates human errors which often occur when cash is distributed at gaming establishment interfaces, such as casino desks and/or cashless ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued cashless ticket voucher than the patron deserves) but also protects the gaming establishment (if the gaming establishment personnel inadvertently or fraudulently provides the patron a higher amount of cash and/or or a higher valued cashless ticket voucher than the patron deserves).

Accordingly, the system of the present disclosure provides an alternative, non-cash-based and non-ticket voucher-based option for a gaming establishment patron to transfer, with or without the employment of any gaming establishment accounts, funds to a gaming establishment device while complying with various anti-money laundering regulations and/or responsible gambling limitations which require the tracking of certain financial transactions associated with a gaming establishment patron.

In various embodiments, the present disclosure is directed to a system including or otherwise in communication with various components and/or sub-systems that operate together to cause a transfer of an amount of funds from an external account, such as a financial institution account, to a gaming establishment device, such as an electronic gaming machine, independent of any cashless ticket vouchers (e.g., an anonymous bearer instrument associated with an amount of funds and redeemable for cash via a kiosk, a cashier and/or game play on a gaming establishment device). In these embodiments, the collection of components that are part of the system (or otherwise operate with one or more components of the system) facilitate a transfer funds from an external account associated with a user to a gaming establishment device with or without a transfer of such funds to a gaming establishment account followed by a wagering account transfer of the funds to the gaming establishment device.

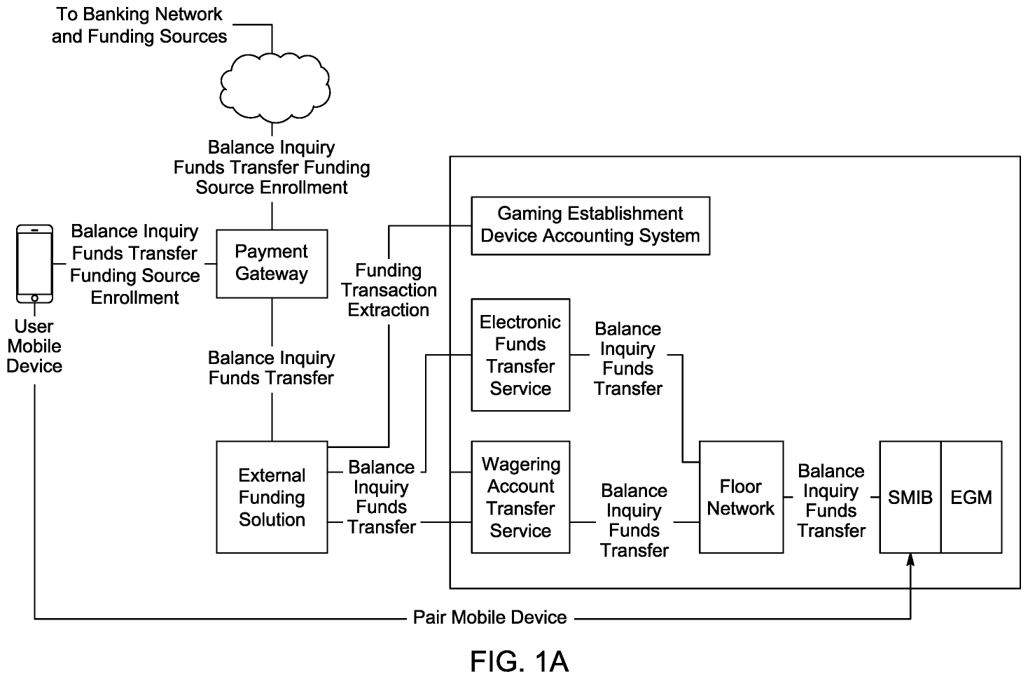

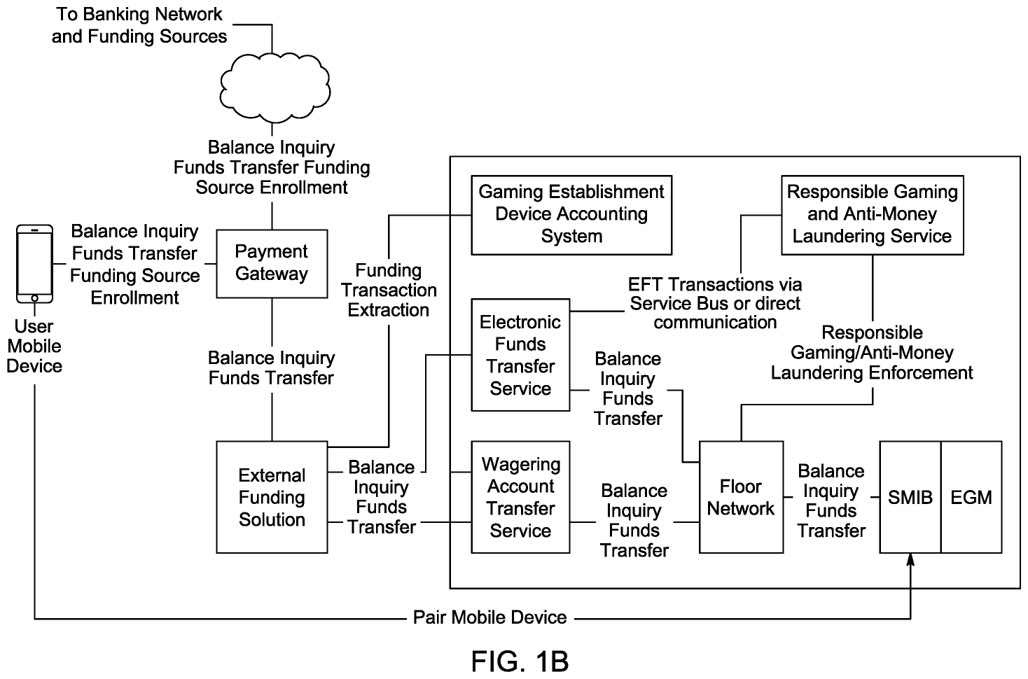

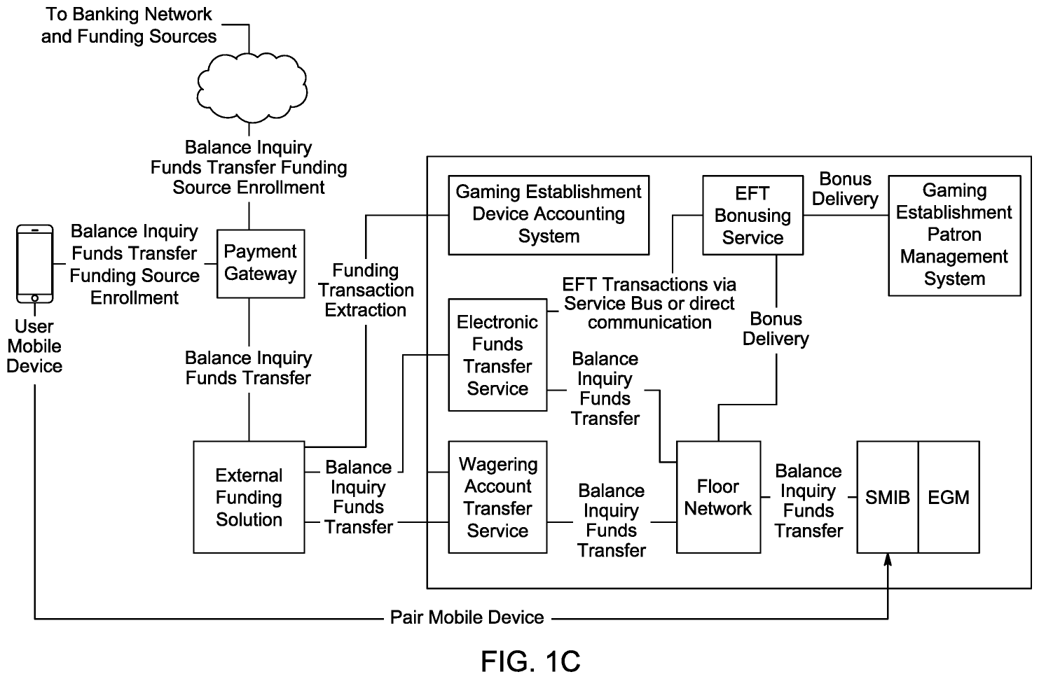

In various embodiments, the system includes or is otherwise associated with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIGS. 1A, 1B and 1C, the system includes one or more servers operating as a payment gateway in communication with a network of one or more servers of one or more banks or other financial institutions (i.e., the banking network and funding sources) which operate to electronically transfer funds from one or more accounts maintained at such banks or financial institutions to an electronic gaming machine (“EGM”) via a series of one or more intermediaries operating directly or indirectly with the payment gateway. As also seen in FIGS. 1A, 1B and 1C, the payment gateway is in communication with a mobile device which enables a user to conduct balance inquiries, request funding source enrollments and/or request fund transfers from one or more external funding sources. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts).

In certain embodiments, the system includes or is otherwise associated with an external funding solution operable with the payment gateway. In these embodiments, the external funding solution enables for a single entry point for all external funding transactions and operates to route funds transferred from one or more external funding sources to one or more components to effectuate such a transfer. For example, as seen in FIGS. 1A, 1B and 1C, the system includes one or more servers operating as an external funding solution in communication with one or more servers of the payment gateway to enable certain actions, including, but not limited to, balance inquiries, and/or fund transfers.

In certain embodiments, the system includes or is otherwise associated with an electronic funds transfer service operable with the external funding solution. In these embodiments, if involved in a gaming establishment device funding transaction, the electronic funds transfer service operates with a gaming establishment device management system to direct funds transferred from the external funding source to the appropriate gaming establishment device separate and apart from any gaming establishment accounts maintained by a gaming establishment fund management system. For example, as seen in FIGS. 1A, 1B and 1C, the system includes one or more servers operating as an electronic funds transfer service in communication with the external funding solution to enable certain actions, including, but not limited to, balance inquiries, and/or fund transfers. As also seen in FIGS. 1A, 1B and 1C, the electronic funds transfer service is also in communication with one or more components of a gaming establishment floor management system (i.e., the floor network) to enable certain actions, including, but not limited to, balance inquiries, and/or fund transfers.

In certain embodiments, the system includes or is otherwise associated with an gaming establishment fund management system operable with the external funding solution. In these embodiments, if involved in a gaming establishment device funding transaction, the gaming establishment fund management system operates with the external funding solution to fund a gaming establishment account, such as a cashless wagering account, maintained by the gaming establishment fund management system. In such embodiments, following the funding of the gaming establishment account, the gaming establishment fund management systems operates with a gaming establishment device management system to direct funds transferred from the external funding source to the appropriate gaming establishment device. For example, as seen in FIG. 1A, the system includes one or more servers operating as a wagering account transfer service in communication with the external funding solution to enable certain actions, including, but not limited to, balance inquiries, and/or fund transfers. As also seen in FIG. 1A, the wagering account transfer service is also in communication with one or more components of a gaming establishment floor management system (i.e., the floor network) to enable certain actions, including, but not limited to, balance inquiries, and/or fund transfers.

In certain embodiments, the system includes or is otherwise associated with a responsible gaming and anti-money laundering service operable with the electronic funds transfer service and the gaming establishment device management system. In these embodiments, if a funding pathway employing an electronic funds transfer is employed, the responsible gaming and anti-money laundering service operates with the electronic funds transfer service to monitor transactions occurring in association with the electronic funds transfer service for potential violations of responsible gaming limits and/or for activities potentially representative of money-laundering activities. In such embodiments, following one or more determinations made by the responsible gaming and anti-money laundering service based on data communicated from the electronic funds transfer service (and/or data published to a service bus by the electronic funds transfer service), the responsible gaming and anti-money laundering service operates with a gaming establishment device management system to potentially cause one or more responsible gaming limits to be invoked and/or cause one or more anti-money laundering actions to be undertaken in association with the appropriate gaming establishment device. For example, as seen in FIG. 1B, the system includes one or more servers operating as a responsible gaming and anti-money laundering service in communication with the electronic funds transfer service to enable certain actions, including, but not limited to, reviewing electronic funds transfer transactions. As also seen in FIG. 1B, the responsible gaming and anti-money laundering service is in communication with one or more components of a gaming establishment floor management system (i.e., the floor network) to enable certain actions, including, but not limited to, notifying of certain responsible gaming limits, enforcing certain responsible gaming limits, notifying of certain potential money laundering activities and/or enforcing certain anti-money laundering efforts

In certain embodiments, the system includes or is otherwise associated with an electronic funds transfer bonusing service operable with the electronic funds transfer service, the gaming establishment device management system, and the gaming establishment patron management system. In these embodiments, if a funding pathway employing an electronic funds transfer is employed, the electronic funds transfer bonusing service operates with the electronic funds transfer service to monitor transactions occurring in association with the electronic funds transfer service and potentially causes one or more bonus events to occur based on such monitored transactions. In such embodiments, following one or more determinations made by the electronic funds transfer bonusing service based on data communicated from the electronic funds transfer service (and/or data published to a service bus by the electronic funds transfer service), the electronic funds transfer bonusing service operates with a gaming establishment device management system (to potentially cause a triggering of a bonus event in association with the appropriate gaming establishment device) and/or a gaming establishment patron management system (to potentially cause a bonus event to be associated with a gaming establishment patron management system account associated with a user). For example, as seen in FIG. 1C, the system includes one or more servers operating as an electronic funds transfer bonusing service in communication with the electronic funds transfer service to enable certain actions, including, but not limited to, reviewing electronic funds transfer transactions. As also seen in FIG. 1C, the electronic funds transfer bonusing service is in communication with one or more components of a gaming establishment floor management system (i.e., the floor network) to enable certain actions, including, but not limited to, a delivery of a bonus event at a gaming establishment device. As further seen in FIG. 1C, the electronic funds transfer bonusing service is in communication with one or more components of a gaming establishment patron management system to enable certain actions, including, but not limited to, a delivery of a bonus event in association with a user account maintained by the gaming establishment patron management system.

In certain embodiments, the system includes or is otherwise associated with a gaming establishment device accounting system operable to monitor transactions occurring in association one or more of the components of (or otherwise operable with) the system of the present disclosure. For example, as seen in FIGS. 1A, 1B and 1C, the system includes or is otherwise associated with one or more components of a gaming establishment device accounting system in communication with at least the external funding solution and operable to, amongst other tasks, extract funding transaction information for accounting and auditing purposes.

In certain embodiments, the system includes or is otherwise in communication with one or more gaming establishment patron management systems that, amongst other tasks, monitor activities at various points of contact associated with a gaming establishment and provides rewards, such as redeemable player tracking points, in association with such activities. In these embodiments, one or more components of the gaming establishment patron management system that are associated with an individual gaming establishment device operate with the gaming establishment device management system to facilitate the transfer of funds from an external funding source to that individual gaming establishment device. For example, as seen in FIGS. 1A, 1B and 1C, the system employs a slot machine interface board (“SMIB”) (i.e., a component of a gaming establishment patron management system) associated with an EGM and in communication with one or more components of a gaming establishment floor management system (i.e., the floor network) to enable certain actions, including, but not limited to, balance inquiries, and/or fund transfers. In these embodiments, one or more components of the gaming establishment patron management system that are associated with an individual gaming establishment device also operate with a mobile device of a user to enable the component of the gaming establishment patron management system to, if necessary, identify, to the payment gateway, the gaming establishment device that will receive the funds from the external funding source. For example, as seen in FIGS. 1A, 1B, and 1C, the system employs the SMIB associated with the EGM to pair with a mobile device that is in communication with the payment gateway to enable the payment gateway (and one or more intermediate components) to identify the appropriate EGM to transfer funds to if such funds are routed along a fund pathway independent of the wagering account transfer service.

In certain embodiments, the system utilizes one mobile device application to interact with the different components of the system to, amongst other actions, access funds maintained in the different external accounts associated with the user. In certain embodiments, the system utilizes multiple mobile device applications to interact with the different components of the system to, amongst other actions, access funds maintained in the different external accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code). Additionally, while illustrated in FIG. 1A as using a mobile device running a mobile device application to access funds associated with an external account, in different embodiments, a physical instrument, such as a smart card or a user issued magnetic stripe card which the user utilizes via inserting the card into a card reader associated with a gaming establishment device (that may or may not be associated with the external account) may additionally or alternatively be utilized to enable a user access to such an external account.

While illustrated as certain systems, sub-systems or components being in communication with other systems, sub-systems or components, any system, sub-system or component of the present disclosure can be in communication with one or more other systems, sub-systems or components to facilitate, as appropriate, the transfer of funds from an external account to a gaming establishment device (dynamically determined to include or bypass any wagering account transfers). For example, while the payment gateway is illustrated in FIG. 1 as being in communication with a banking network and one or more external funding sources, in different embodiments, any system, sub-system or component of the present disclosure can be in communication with a banking network and one or more external funding sources.

Moreover, in certain embodiments, two or more of the systems, sub-systems and components of the present disclosure may be combined into a single system, sub-system or component. For example, while the payment gateway and external funding solution are illustrated as separate components, the payment gateway and external funding solution may be combined into a single component operable to interface with a banking network and one or more external funding sources and determine which funding pathway to employ to facilitate a transfer of funds from an external account to a gaming establishment device.

It should be appreciated that while illustrated in FIG. 1A as a mobile device running a mobile device application being in communication with certain components of the present disclosure, any suitable device, such as, but not limited to, a kiosk, a gaming establishment device (e.g., an interface of a gaming device, such as an EGM, or an interface of a non-gaming device, such as a retail point-of-sale terminal associated with a gaming establishment), an externally controlled interface displayed by a gaming establishment device (e.g., a remote host controlled service window displayed by an EGM), a component of a gaming establishment patron management system, such as a player tracking unit, and/or a gaming establishment interface, may be in communication with certain components of the present disclosure to facilitate the transfer of funds from an external account to a gaming establishment device (dynamically determined to include or bypass any wagering account transfers).

It should be further appreciated that while illustrated in FIG. 1A as funds accessed from an external funding source being transferred to an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)), in different embodiments, funds accessed from an external funding source may be transferred to any suitable non-EGM gaming establishment device operable to receive funds, such as, but not limited to, a kiosk or a retail point-of-sale terminal associated with a gaming establishment.

As described in more detail below, in certain embodiments, the system enables a transfer of funds between different external accounts and different gaming establishment components to enable different gaming activities and/or non-gaming activities. In these embodiments, the system employs a service for interfacing with the various components to facilitate balance inquiries and the transfer of funds (dynamically determined to include or bypass any wagering account transfers). In certain embodiments, such a service collects data from various components and utilizes such collected data to provide a singular view of the balances (or a plurality of singular views of different groupings of balances) available. As also described in more detail below, in certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. As also described in more detail below, in certain embodiments, such a service additionally or alternatively enables one or more bonus events to be triggered based on certain funding criteria. In certain embodiments, such a service additionally or alternatively tracks and coalesces transaction history of the interconnected components of the system. In these embodiments, all transactions within the system have a “master” transaction record that ties all of the various fund transfers to a single initiating funds transfer regardless of how many accounts were withdrawn to the satisfy the original request.

In various embodiments, prior to transferring funds associated with an external account maintained by an external funding source to a gaming establishment device, such as an EGM, the user enrolls or otherwise associates an external account maintained by an external funding source. In certain embodiments, if the user has not previously enrolled the external account and/or the external funding source with the payment gateway, the system enables the user to enroll the external account and/or the external funding source with the payment gateway. For example, the system of the present disclosure enables a user to enroll a bank account with the system using a mobile device application. In certain instances, such enrollment occurs independent of requiring the user to logon to any gaming establishment mobile device application or otherwise identify themselves to a gaming establishment patron management system. In these instances, the user remains anonymous to the gaming establishment because the act of enrolling the bank account maintained by the bank is between the user, the mobile device application and the user's bank.

In various embodiments, to enroll an external account and/or an external funding source with the payment gateway, the system enables a user to utilize an interface, such as a mobile device application being executed by a mobile device, a website accessed from a browser, a kiosk and/or a service window displayed by EGM (or other gaming establishment device), to attempt to complete the enrollment through one or more interactive forms. For example, as part of enrolling an external account and/or an external funding source, the user makes one or more inputs via an interface to provide certain user identifying information (such as, but not limited to, name, address, birthdate, state of birth, additional address details, a social security number and/or a mother's maiden name) and/or certain external account identifying information (such as, but not limited to, an identification of a funding source, an external account number, a unique username/password combination associated with the user to access the external account).

Accordingly, in various embodiments, the system of the present disclosure enables a user to enroll an external account maintained by an external funding source with the payment gateway to enable the transfer of funds from the external account to a gaming establishment device (dynamically determined to include or bypass any wagering account transfers). For example, certain embodiments of enrolling an external account maintained by an external funding source with the payment gateway include a user employing a gaming establishment mobile device application to access a mobile device application associated with a funding source to enable the payment gateway to interface with one or more servers of the funding source to enroll the external account maintained by the external funding source such that subsequent transfers to the gaming establishment device are separately available to potentially occur.

In certain embodiments, as part of enrolling an external account and/or an external funding source, the system determines zero, one or more security measures to invoke in association with one or more (or each) transaction that involves funds transferred from the external account. In these embodiments, to prevent unauthorized access to the funds associated with such an external account, the system applies such determined security measures in association with one or more (or each) transaction that attempts to transfer funds from the external account. In certain embodiments, as part of enrolling an external account and/or an external funding source, the system determines one or more controls or restrictions to associate with the external account wherein if such controls are violated, the system invokes one or more security measures. In these embodiments, to balance the need to prevent unauthorized access to the funds associated with an external account against the need to provide a frictionless experience for users, the system dynamically employs one or more security measures such that certain transactions that trigger the need to employ enhanced security measures and certain transactions that do not trigger the need to employ enhanced security measures. It should be appreciated that an enhanced security measure includes any form of security that was not otherwise associated with the transaction prior to the determination that the nature of the transaction warranted an additional degree of protection to combat any attempted fraud associated with the transaction. For example, if a user is required to enter a personal identification number (“PIN”) for each attempted transfer of funds from an external account regardless of any determination that the nature of the transaction warrants any additional degree of protection to combat any attempted fraud associated with the transaction, such a PIN would not qualify as an enhanced security measure. In another example, if a user is not required to enter a PIN for each attempted transfer of funds from an external account but following a determination that the nature of the transaction warrants requiring the user to enter a PIN as an additional degree of protection to combat any attempted fraud associated with the transaction, such a PIN would qualify as an enhanced security measure. In certain embodiments, the external account is associated with a transaction completion time (i.e., an amount of time a financial institution associated with the external account needs to approve or disapprove the fund transfer and make the amount of funds available). As such, since different external accounts are associated with different transaction completion times, the user may enroll different external accounts and utilize the funds from different external accounts at different points in time based on the respective transaction completion times of these different external accounts.

In certain embodiments, following the enrollment of an external funding source and/or an external account associated with a user, to request a transfer of an amount of funds from the external account maintained by the external funding source to the gaming establishment device, a user utilizes a physical instrument (e.g., a smart card or a user issued magnetic striped card which the user utilizes via inserting the card into a card reader associated with the gaming establishment device) to enable the user to identify themselves to the gaming establishment device (and the payment gateway) and interface with the gaming establishment device (or a component associated with the gaming establishment device) to request an electronic transfer of funds from the external account to the gaming establishment device.

In certain embodiments, following the enrollment of an external funding source and/or an external account associated with a user, to request a transfer of an amount of funds from the external account maintained by the external funding source to the gaming establishment device, a user pairs a mobile device with the gaming establishment device. In certain instances in which the funds are transferred to the gaming establishment device independent of any gaming establishment fund management system, such pairing enables the system to identify the gaming establishment device which the funds are to be delivered to. For example, if the system determines to transfer an amount of funds from an external account associated with a financial institution to an EGM without employing any gaming establishment accounts and/or wagering account transfers, a user pairs a mobile device (which is executing a gaming establishment mobile device application operable to access or otherwise launch a mobile device application associated with the financial institution) with a SMIB (i.e., a component of the gaming establishment patron management system) associated with the EGM. The result of this pairing enables the system to identify the EGM and the gaming establishment (and/or a gaming establishment site if the gaming establishment is associated with multiple sites) to ensure that the funds are transferred to the correct EGM at the correct gaming establishment.

In certain embodiments, the pairing between a mobile device and a component of a gaming establishment patron management system associated with a gaming establishment device is accomplished by one or more wireless communication protocols between the mobile device and the component of the gaming establishment patron management system associated with a gaming establishment device (or the gaming establishment device itself). In certain embodiments, the communication with the mobile device can occur through one or more wireless interfaces of the gaming establishment device (described herein as an EGM but not otherwise limited to an EGM) and/or the component of the gaming establishment patron management system (described herein as a SMIB but not otherwise limited to a SMIB) associated with the gaming establishment device. Such wireless interfaces are configured to receive information employed to facilitate a transfer of funds from an external account to an EGM with or without the employment of any gaming establishment accounts.

In one embodiment, the wireless interface is integrated into a device mounted to and/or within the gaming machine cabinet, such as a SMIB associated with a card reader or a player tracking unit. In another embodiment, the wireless interface is integrated into the cabinet of the EGM and the EGM processor is configured to communicate directly with and send control commands to the wireless interface. In certain embodiments where the wireless interface is embedded in a secondary device, such as a SMIB, the EGM processor sends control commands to control the wireless interface via a secondary controller.

In certain embodiments, the wireless interface implements one or more wireless communication protocols including, but not limited to: Bluetooth™, Bluetooth™ Low Energy (“BLE”), one or more cellular communication standards (e.g., 3G, 4G, 5G, 6G, LTE), and/or one or more Wi-Fi compatible standards to facilitate the pairing between the mobile device and the SMIB (or the EGM) to enable a transfer of funds from an external account to the EGM.

In certain such embodiments, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network. In such embodiments, utilizing a Wi-Fi/Bluetooth™ communications protocol implementation, the mobile device communicates with the SMIB (or the EGM) via a Wi-Fi/Bluetooth™ communications protocol.

In certain embodiments which implement a wireless communication protocol, such as a Wi-Fi, cellular and/or Bluetooth™ communication protocol, the system utilizes one or more QR codes to facilitate the communication of data between the mobile device and the SMIB (or the EGM). In such embodiments, the QR code is used to identify the SMIB, the EGM and/or a server to which the mobile device should connect. In certain embodiments, the QR code enables the establishment of a secure tunnel or path from the mobile device to the gaming establishment's Wi-Fi network and then to the gaming establishment's wired network and finally to the SMIB (or the EGM). In these embodiments, a communication tunnel wrapper (e.g., a Wi-Fi/Bluetooth™ tunnel wrapper) is utilized to establish a connection between the SMIB (or the EGM or a server associated with the SMIB or associated with the EGM) and the mobile device and to transport any data messages between the SMIB (or the EGM or a server associated with the SMIB or associated with the EGM) and the mobile device.

In certain embodiments, the QR code comprises a static QR code, such as a sticker or metallic plate affixed to the EGM. In certain such embodiments, the QR code uniquely identifies the particular SMIB (or the EGM) directly or indirectly, such as representing a value in a database that is associated with that particular SMIB (or particular EGM). In certain embodiments, the QR code comprises a dynamic QR code that is displayed by a display device associated with the SMIB (or the EGM), such as a QR code displayed by a service window. In these embodiments, a user requests, via an input at the SMIB, the EGM and/or the mobile device, the generation of a QR code. In response to the request, the SMIB or the EGM displays a QR code. Such an on-demand QR code remains valid for a designated amount of time such that if the user does not scan the QR code within the designated amount of time, another QR code is necessary to be scanned to connect the mobile device to the SMIB (or the EGM). For example, a QR code is displayed for thirty seconds after which the QR code is no longer displayed. In this example, if another user attempts to scan the QR code after this thirty second window, that other user would need to request, via an input at the SMIB or the EGM, the generation of another separate QR code. As such, to avoid the QR code displayed in association with a given EGM from always have the same data embedded in it because an intruder could scan the QR code and then try to login an hour later to that same EGM, the system requires the user to engage a button on the SMIB or the EGM to display the QR code. This engagement triggers a new QR code that has a unique nonce in it which prevents a third-party (e.g., another user) from sniping information utilized to facilitate the transfer of funds from the external account to the EGM.

In certain embodiments, a user scans a QR code with the mobile device application. If the system determines that the QR code is valid (i.e., not expired), the mobile device application will connect to one or more components of the system, such as the SMIB, the EGM and/or a server operable to identify the SMIB or the EGM. For example, when the mobile device connects to a scalable server, a validation occurs of the nonce scanned and presented to the scalable server. In this example, only if the nonce matches will the system enable the connection. It should be appreciated that as long as the established connection between the mobile device and the system remains active, one or more servers and mobile device may communicate data, such as status updates, as necessary. It should be further appreciated that in association with the wireless communications protocol that employ a QR code, any action requested by the user via the mobile device application does not require a new engagement between the mobile device and the SMIB or the EGM, such as a new scanning of the QR code to send such a requested action from the mobile device to the SMIB, to the EGM and/or to one or more servers and then from one or more servers to the SMIB or the EGM.

In certain embodiments, the wireless interface implements an NFC protocol to facilitate the pairing of the mobile device with the SMIB (or the EGM) to enable the transfer of funds from an external account to the EGM. NFC is typically used for communication distances of four cm or less. NFC enables for transactions, data exchange, and connections with a touch. NFC's short range helps keep encrypted identity documents private. As such, a tap of a mobile device with an NFC chip to an EGM can cause a pairing between the SMIB (or the EGM) and the mobile device.

Specifically, utilizing an NFC implementation, a mobile device communicates with the SMIB (or the EGM) via an NFC protocol. In such embodiments which utilize the NFC implementation, the mobile device application registers a mobile device application with one or more processors of the mobile device. When the mobile device is detected by an NFC reader of or otherwise associated with the SMIB located inside the EGM (or the EGM), the SMIB communicates one or more data messages to the mobile device (or to one or more servers which then communicate such data messages to the mobile device). Such data messages are commands generated by the SMIB (or the EGM) when the mobile device is detected in the NFC reader field. The processor of the mobile device communicates the data message to the registered mobile device application. The mobile device application responds, such as communicating a triggering message, and a communication channel is opened between the SMIB (or the EGM) and the mobile device application (or between the SMIB, the EGM, and/or one or more servers and the mobile device application). This open communication channel enables the SMIB (or the EGM) to send, though the NFC reader, additional data messages to the mobile device (or to the mobile device via one or more servers) which are responded to by the mobile device application of the mobile device. It should be appreciated that as long as the mobile device remains within the NFC field, the SMIB (or the EGM) is configured to communicate with the mobile device and send data, such as status updates, as necessary. However, once the mobile device is removed from the NFC field, the communication channel is closed and such status updates must be discontinued.

It should be appreciated that Wi-Fi, cellular, Bluetooth™, BLE communication protocols can be used in lieu of or in combination with NFC. For instance, an NFC communication can be used to instantiate a Wi-Fi or Bluetooth™ communication between the SMIB, the EGM, and/or zero, one or more servers and a mobile device, such as secure pairing using one of these protocols. That is, in one embodiment, an NFC interface can be used to set-up a higher speed communication with the NFC enabled mobile device. The higher speed communication rates can be used for expanded content sharing. For instance, a NFC and Bluetooth enabled EGM can be tapped by an NFC and Bluetooth enabled mobile device for instant Bluetooth pairing between the devices and zero, one or more servers. Instant Bluetooth pairing between an EGM, an NFC enabled mobile device and zero, one or more servers, can save searching, waiting, and entering codes. In another example, an EGM can be configured as an NFC enabled router, such as a router supporting a Wi-Fi communication standard. Tapping an NFC enabled mobile device to an NFC enabled and Wi-Fi enabled EGM can be used to establish a Wi-Fi connection between the devices and zero, one or more servers.

In certain embodiments which utilize one or more of the communication protocols described herein, any action requested by the user via the mobile device application requires a new engagement between the mobile device and the SMIB (or the EGM), such as a new tap of the mobile device to a designated location of the EGM. In certain other embodiments which utilize one or more of the communication protocol described herein, certain actions requested by the user via the mobile device application requires a new engagement between the mobile device and the SMIB (or the EGM), such as a new tap of the mobile device to a designated location of the EGM and other actions requested by the user via the mobile device application do not require any new engagement between the mobile device and the SMIB (or the EGM).

In certain embodiments, following the receipt of one or more inputs made via a paired mobile device executing a mobile device application and/or made directly at the EGM, to request a transfer of funds from an external account to an EGM, the system determines whether or not the user is associated with a gaming establishment account, such as a cashless wagering account or other account that utilizes a wagering account transfer. In these embodiments, the user being associated with a gaming establishment account enables the system to utilize a funding pathway that employs that gaming establishment account as an intermediary in the transfer of funds from the external account to the EGM. Additionally, the user not being associated with a gaming establishment account directs the system to utilize a funding pathway that employs a transfer of funds from the external account to the EGM without such a gaming establishment account.

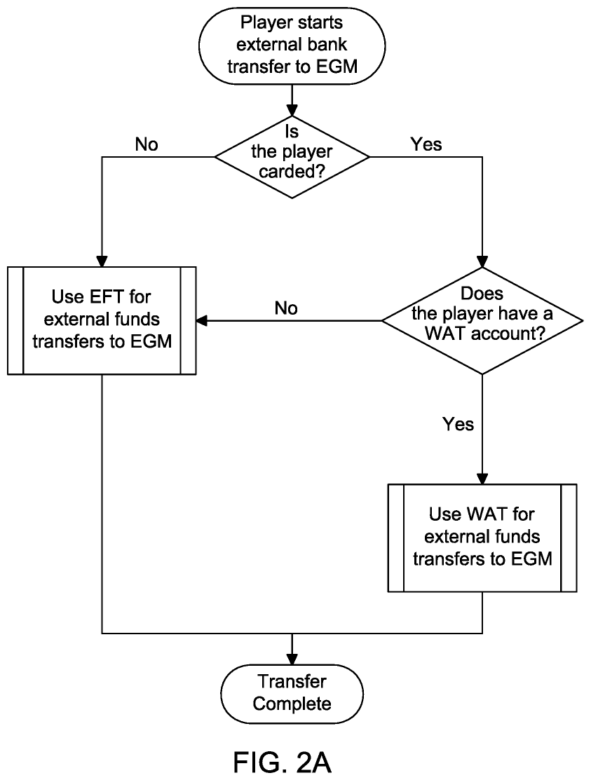

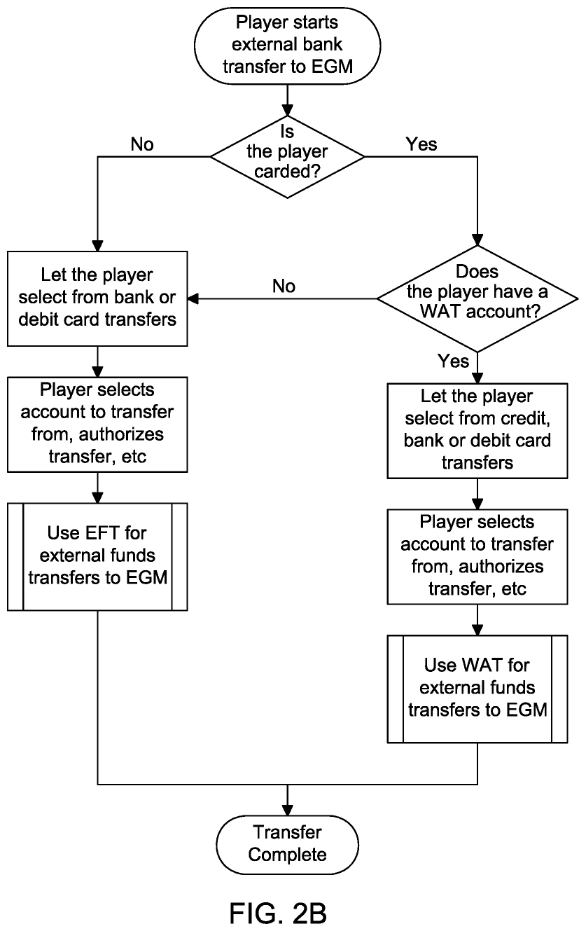

In certain such embodiments, in association with a transfer of funds from an external account to a gaming establishment device, the system first determines if a user associated with the external account has an account maintained by a gaming establishment patron management system, such as a player tracking account maintained by a player tracking system. In these embodiments, since a user without an account maintained by a gaming establishment patron management system would not have a gaming establishment account maintained by a gaming establishment fund management system, such as a cashless wagering account or other account operable to employ wagering account transfer transactions, the system employs an account maintained by a gaming establishment patron management system as a preliminary screen to determine which funding pathway to employ. For example, as seen in FIG. 2A, if a player does not have a gaming establishment patron management system account (e.g., a player tracking account), the player will not have a gaming establishment fund management system account (e.g., a wagering account transfer (“WAT”) account) and the system determines that the only way to fund the gaming establishment device using funds from an external funding source (e.g., a bank account or a debit card) is via an electronic funds transfer.

In these embodiments, if the user has a gaming establishment patron management system account (e.g., a player tracking account), the system determines if that user also has a gaming establishment fund management system account (e.g., a cashless wagering account or other account operable to employ wagering account transfer transactions). That is, since in certain instances, a user may be required to sign up for a gaming establishment fund management system account (e.g., a cashless wagering account or other account operable to employ wagering account transfer transactions) separate and distinct from the signup process for a gaming establishment patron management system account (e.g., a player tracking account), certain users who have a gaming establishment patron management system account (e.g., a player tracking account) have a gaming establishment fund management system account (e.g., a cashless wagering account or other account operable to employ wagering account transfer transactions), while other users may not, the system determines if a user with a gaming establishment patron management system account also has a gaming establishment fund management system account. As further seen in FIG. 2A, even if a player has a gaming establishment patron management system account (e.g., a player tracking account), if the system determines that the player does not also have a gaming establishment fund management system account (e.g., a WAT account), the system determines that the only way to fund the gaming establishment device using funds from an external funding source (e.g., a bank account or a debit card) is via an electronic funds transfer.

On the other hand, if the system determines that the user with a gaming establishment patron management system account also has a gaming establishment fund management system account, the system determines that the gaming establishment device may be funded using funds from an external funding source (e.g., a bank account or a debit card) via an electronic funds transfer or a wagering account transfer. In such a scenario, since the system prioritizes a funding pathway of wagering account transfers over a funding pathway of electronic funds transfers, as seen in FIG. 2A, the system determines to employ such a funding pathway employing a wagering account transfer to transfer funds from the external account to the gaming establishment device.

In certain other embodiments, in association with a transfer of funds from an external account to a gaming establishment device, the system bypasses any determination of if a user associated with the external account has an account maintained by a gaming establishment patron management system, such as a player tracking account maintained by a player tracking system. In these embodiments, in association with a transfer of funds from an external account to a gaming establishment device, the system determines if the user associated with the external account has a gaming establishment fund management system account maintained by a gaming establishment fund management system, such as a cashless wagering account or other account operable to employ wagering account transfer transactions. In these embodiments, if the system determines that the user does not have a gaming establishment fund management system account maintained by a gaming establishment fund management system, such as a cashless wagering account or other account operable to employ wagering account transfer transactions, the system determines that the only way to fund the gaming establishment device using funds from an external funding source (e.g., a bank account or a debit card) is via an electronic funds transfer. On the other hand, if the system determines that the user has a gaming establishment fund management system account, the system determines that the gaming establishment device may be funded using funds from an external funding source (e.g., a bank account or a debit card) via an electronic funds transfer or a wagering account transfer. In such a scenario, since the system prioritizes a funding pathway employing wagering account transfers over a funding pathway employing electronic funds transfers, the system determines to employ such a funding pathway employing a wagering account transfer to transfer funds from the external account to the gaming establishment device.

In certain embodiments, in association with a transfer of funds from an external account to a gaming establishment device, the system determines which funding pathway to employ based on certain information in addition to the existence of a gaming establishment fund management system account maintained for the user associated with the external account. In such embodiments, in determining a funding pathway, the system utilizes one or more of information provided or associated with the EGM that the user was at when the transfer was triggered, information provided in the request when the user associated their mobile device with a particular EGM, and/or historical information associated with the external funding account used during the external funding process.

In certain embodiments, in association with a transfer of funds from an external account to a gaming establishment device, the system determines which funding pathway to employ based on certain additional criteria. In certain such embodiments, since different funding pathways have different fee structures (e.g., a funding pathway employing electronic funds transfers may be more or less expensive than a funding pathway employing a wagering account transfer), the system accounts for such fee structures in determining which funding pathway to use to transfer funds from an external account to an EGM. In certain additional or alternative embodiments, since different funding pathways have different timeframes to complete the funding transaction (e.g., a funding pathway employing electronic funds transfers may take more or less time to complete than a funding pathway employing a wagering account transfer), the system accounts for such timing aspects in determining which funding pathway to use to transfer funds from an external account to an EGM.

In certain embodiments, based on certain attributes of a user associated with an external account transfer transaction, the system determines to waive part or all of any imposed fees associated with the fee structure of the determined funding pathway used to transfer of funds from the external account. In certain such embodiments, since users having an account maintained by a gaming establishment patron management system, such as a player tracking account, are known to the gaming establishment, the system waives part or all of fees associated with a funding pathway employing a wagering account transfer for certain users. In these embodiments, based on one or more of an anticipated spend of a known user, a ranking of a known user, a historic spend of a known user and/or one or more balances associated with that known user, the system determines whether or not to waive (or otherwise cover) part or all of the fees associated with a funding pathway employing a wagering account transfer. In comparison, since users that transfer funds from an external account using a funding pathway employing electronic funds transfers are more anonymous to the gaming establishment, the system determines not to waive (or otherwise cover) part or all of the fees associated with a funding pathway employing electronic funds transfers.

In certain additional or alternative embodiments, based on certain attributes of an external account transfer transaction, the system determines to waive part or all of any imposed fees associated with the fee structure of the determined funding pathway used to transfer of funds from the external account. In these embodiments, based on one or more of an amount of funds transferred from an external account, a timing of funds transferred from the external account, an external funding source which maintains the external account, historical transfers from the external account, historical transfers from the external funding source and/or the type of funding pathway employed, the system determines whether or not to waive (or otherwise cover) part or all of the fees associated with the funding pathway employed. For example, to encourage users to sign up for a gaming establishment account that utilizes wagering account transfers, the system determines to waive (or otherwise cover) part or all of the fees associated with a funding pathway employing a wagering account transfer (but not a funding pathway employing electronic funds transfers) for some or all transfers, such as transfers at least a threshold amount and/or fund transfers made on a certain day of the week.

In operation of certain embodiments, following the user selecting an external funding source and indicating an amount of funds to transfer from the external account, the system initiates a requested transfer of funds from the external funding source to an EGM. In these embodiments, following any required authentication with the funding source and subject to the transfer being approved, one or more components of a financial institution system that maintains the external account operate to transfer an amount of funds from the external account to an EGM via one or more intermediate components of the system of the present disclosure that individually or collectively determine the appropriate funding pathway to employ and then operate to effectuate the transfer of funds to the EGM.

In certain embodiments, the system employs a mobile device that is paired with a SMIB and executing a mobile device application that a user interfaces with to log into an enrolled external account maintained by the external funding source and interact with the payment gateway. In certain such embodiments, the mobile device application enables the user to input data for accessing the external account and/or information regarding the amount of the transfer using one or more input devices of the mobile device, such as inputting a PIN and/or scanning a payment instrument associated with the external account (e.g., a debit card or a credit card). For example, following the launching of the mobile device application, such as following the user selecting an image associated with the external account stored via a digital wallet application or following the mobile device application retrieving data associated with an external account stored via a digital wallet application, the mobile device application prompts the user to make zero, one or more inputs to select a funding source and, in certain instances, authenticate that funding source, such as authenticating an external account and/or confirming information associated with the external account (e.g., confirming a CVC or CVV code on a debit card associated with a checking account).

In certain embodiments, the mobile device communicates, to the payment gateway, certain data for identifying the external account, data for identifying the user and/or data for authenticating the external account or the user, such as, but not limited to, an identification of a funding source, an external account number, a unique username/password combination associated with the user to access the external account, a PIN to access the external account, biometric data received by a biometric sensor (e.g., a fingerprint sensor, a retinal sensor, a voice sensor, or a facial-recognition sensor) of the mobile device to access the external account and/or any other suitable information. In these embodiments, the payment gateway employs the data communicated from the mobile device to interact with the banking network and the external funding source to at least partially facilitate the transfer of funds from the external account. In certain other embodiments, a user is associated with default funding data, such as a default funding source, a default external account, a default transfer amount and/or a default payment instrument, such that following the identification of the EGM to transfer funds to from an external account, the payment gateway employs the associated default funding data to interact with the banking network and the external funding source to at least partially facilitate the transfer of funds from the external account.

Following the payment gateway receiving the data for accessing the external account (either from the mobile device, a server in communication with the mobile device, and/or from the user independent of the mobile device, such as via a kiosk reading information from a debit card associated with the external account), the payment gateway proceeds with operating with one or more components that operate to log the user into the external account to initiate any transfers of funds from such an external account. That is, to transfer funds from an external account, the payment gateway communicates data regarding the requested transfer of funds to one or more servers of a financial institution that maintains the external account. The one or more servers of the financial institution that maintain the external account then determines whether or not to authorize the requested transfer of funds from the external account.

If the determination is to not authorize the requested transfer of funds (i.e., the external account lacks adequate funds to cover the requested transfer and/or the requested transfer is otherwise in violation of one or more rules and regulations), the one or more servers of the financial institution denies the requested transfer of funds and communicates data of the denied transfer to the payment gateway and/or the mobile device. In certain embodiments, such a denial of the transfer is associated with the display of one or more denied transfer messages to the user.

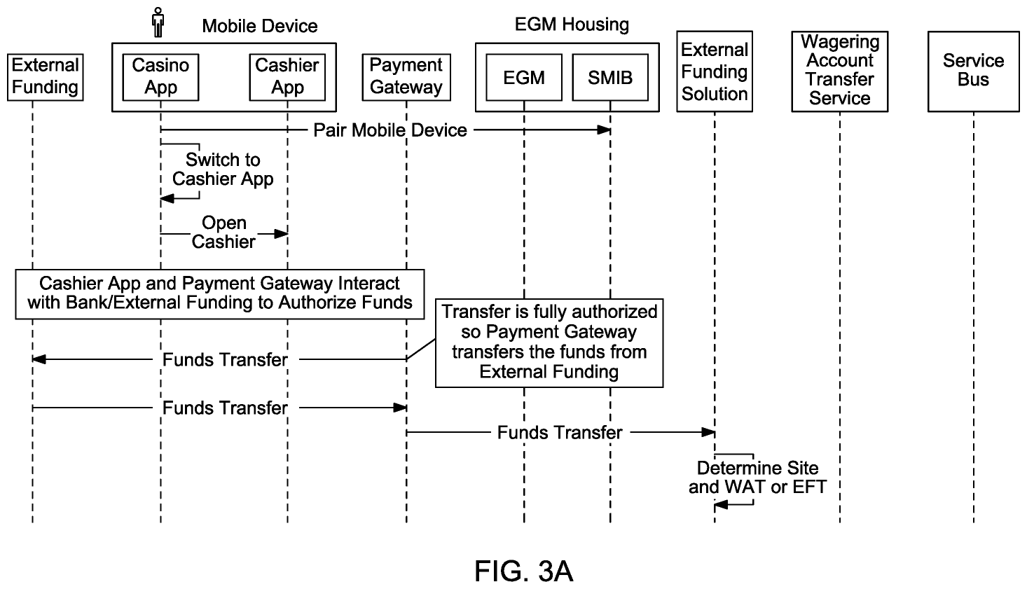

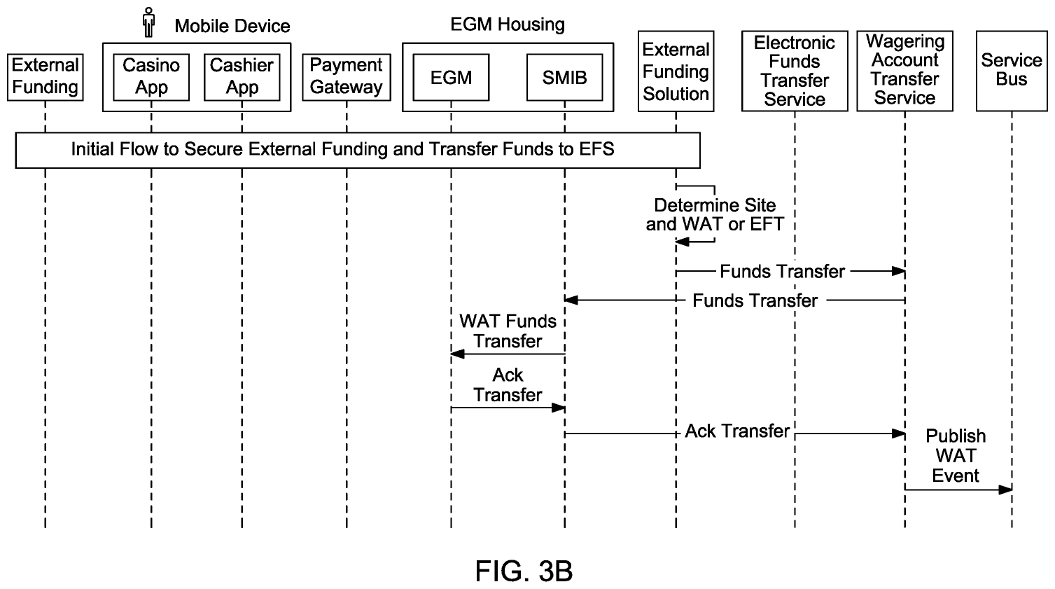

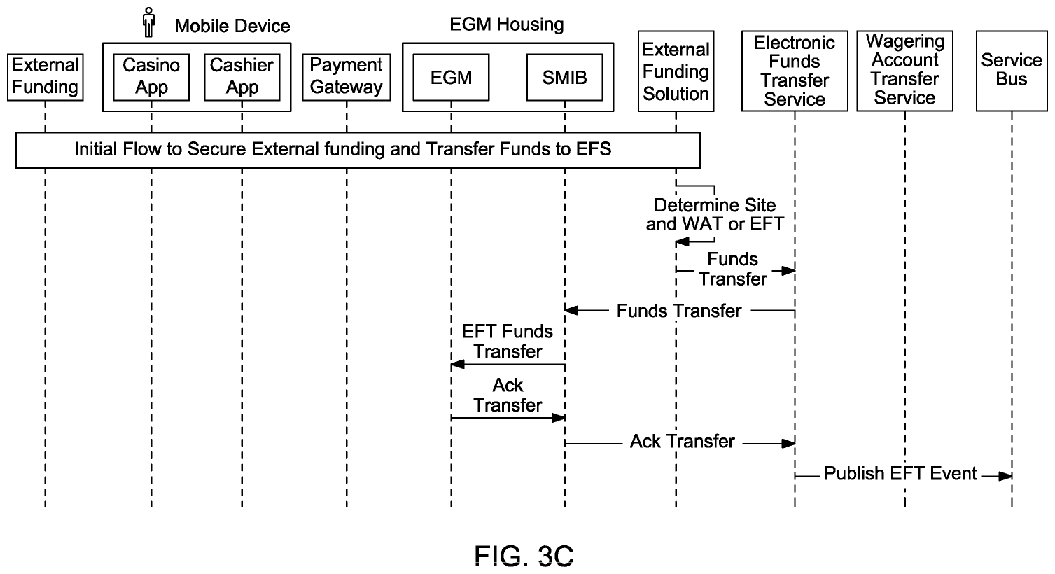

On the other hand, if the determination is to authorize the requested transfer of funds (i.e., the external account has adequate funds to cover the transfer and the requested transfer is otherwise in compliance with zero, one or more rules and regulations), the one or more servers of the financial institution communicates data associated with the authorization of the transfer to the payment gateway. The payment gateway of these embodiments then operates with one or more components of the system of the present disclosure to determine a funding pathway and cause a transfer of the amount of funds from the external account to the EGM in accordance with the determined funding pathway. Put differently, following the external funding source authorizing the transfer of funds from an external account maintained by the external funding source, the external funding source transfers fund data to the payment gateway which then transfers part or all of such fund data to one or more other components of the system (e.g., the external funding solution) which operate, individually or collectively, to determine a funding pathway to employ and cause a transfer such funds to the EGM via the determined funding pathway. For example, as seen in FIG. 3A, (which illustrates the described interactions between an external funding source, a mobile device executing mobile device applications, an EGM, a SMIB associated with the EGM, the payment gateway, and the external funding solution), certain embodiments of transferring funds from an external account maintained by an external funding source to an EGM associated with a SMIB paired to a mobile device include a user employing a gaming establishment mobile device application (i.e., the casino app) to access a mobile device application associated with a funding source (i.e., the cashier app) and the payment gateway interfacing with one or more servers of the funding source (i.e., the external funding). As also seen in FIG. 3A, following the one or more servers of the funding source (i.e., the external funding) authorizing the transfer, one or more intermediate components, such as the external funding solution, operate to determine which funding pathways are available to potentially employ and also determine, based on any applicable priority of the available funding pathways, which funding pathway to utilize to transfer funds from the external account to the EGM.

In certain embodiments, in addition to determining a funding pathway to employ, if needed, certain components of the system additionally determine certain site data to ensure that the funds reach the identified EGM. For example, if a gaming establishment is associated with multiple sites, an intermediary component that is aware of these multiple gaming establishment sites, such as the external funding solution, provides the disambiguation between such sites to enable for the successful transfer from the funding source to the correct gaming establishment site and the correct EGM within that site. In other words, the system provides that a transfer from a funding source is routed to a multi-site aware intermediary component and that multi-site aware intermediary component determines, if necessary, which site specific intermediary component to forward the transaction to. In another example, certain intermediary components operate to provide protocol translations between intermediaries components and/or transaction logging for accounting and/or auditing purposes (e.g., to be reported to one or more accounting systems).

In certain embodiments, if the system determines to utilize a funding pathway that employs a gaming establishment fund management system account (e.g., a cashless wagering account or other account operable to employ wagering account transfer transactions) maintained by a gaming establishment fund management system (e.g., a gaming establishment cashless wagering system), following the authorization of the amount of funds from the external funding source, the system employs a wagering account transfer to transfer the amount of funds to the EGM via the funds first being transferred to the user's gaming establishment fund management system account (e.g., a cashless wagering account or other account operable to employ wagering account transfer transactions) and then transferred from such a gaming establishment fund management system account to a credit balance of the EGM. For example, as seen in FIG. 3B (which illustrates the described interactions that occur between the wagering account transfer service, a service bus, a SMIB and an EGM), following a determination by the external funding solution to employ a wagering account transfer funding pathway, the system operates with a wagering account transfer service to utilize a gaming establishment fund management system account (e.g., a cashless wagering account or other account operable to employ wagering account transfer transactions) and a SMIB to transfer funds from the external funding source to the EGM. Following the successful transfer of funds to the EGM using the wagering account transfer funding pathway, the EGM increases one or more wagering account transfer meters of the EGM to account for the transfer of funds from the external account via this funding pathway and the EGM increases a displayed credit balance of the EGM to account for the transfer of funds from the external account. In certain embodiments, such an approval and/or completion of the transfer is associated with the display of one or more approved and/or completed transfer messages to the user.

In certain embodiments, if the system determines to utilize a funding pathway that operates independent of any gaming establishment fund management system account (e.g., a cashless wagering account or other account operable to employ wagering account transfer transactions) maintained by a gaming establishment fund management system (e.g., a gaming establishment cashless wagering system), following the authorization of the amount of funds from the external funding source, the system employs an electronic funds transfer to transfer, separate and apart from any wagering account transfers, the amount of funds to the EGM. For example, as seen in FIG. 3C (which illustrates the described interactions that occur between the electronic funds transfer service, a service bus, a SMIB and an EGM), following a determination by the external funding solution to employ an electronic funds transfer funding pathway, the system operates with an electronic funds transfer service (which operates independent of any gaming establishment fund management system account) and a SMIB to transfer funds from the external funding source to the EGM. Following the successful transfer of funds to the EGM using the electronic funds transfer funding pathway, the EGM increases one or more Electronic Funds Transfer In meters of the EGM to account for the transfer of funds from the external account via this funding pathway and the EGM increases a displayed credit balance of the EGM to account for the transfer of funds from the external account. In certain embodiments, such an approval and/or completion of the transfer is associated with the display of one or more approved and/or completed transfer messages to the user.

As seen in these different examples, one difference between an electronic funds transfer funding pathway and a wagering account transfer funding pathway is that wagering account transfer funding pathway moves funds to the EGM from a gaming establishment fund management system account, such as a cashless wagering account, associated with a gaming establishment patron management system account, such as a player tracking account, while in an electronic funds transfer funding pathway, there is no involvement of any gaming establishment fund management system account, such as any cashless wagering account, associated with a gaming establishment patron management system account, such as a player tracking account (if the user even has one). As further seen in these examples, another difference between an electronic funds transfer funding pathway and a wagering account transfer funding pathway is the meters of the EGM moved responsive to an amount of funds transferred from an external funding source.

It should be appreciated that in certain embodiments, the funding pathway determined to employ enables different funding options associated with the external funding source. In these embodiments, which funding pathway is used determines one or more of which external funding sources may be accessed to transfer funds to a gaming establishment device. That is, different external funding instruments are made available for a user to select based upon the determination by the system if an electronic funds transfer funding pathway or a wagering account transfer funding pathway will be used. For example, as seen in FIG. 2B, if a wagering account transfer funding pathway is determined to be used, in certain jurisdictions, the user is enabled to leverage credit cards (i.e., a first external funding instrument) in addition to bank account transfers accessed via a debit card (i.e., a second external funding instrument). On the other hand, as also seen in FIG. 2B, if the user does not have an account operable with a wagering account transfer funding pathway such that an electronic funds transfer funding pathway is employed, the user is limited, in certain jurisdictions, to only being able to perform debit card transfers and/or bank account transfers.

Accordingly, in certain embodiments, in association with the movement of funds from an external account to an EGM, the system determines a funding pathway to employ and based on that funding pathway, operates with one or more components to fund the EGM with or without the employment of a gaming establishment account maintained by a gaming establishment fund management system. In these embodiments, since certain funding pathways are preferable over other funding pathways, rather than employ a single funding pathway for all transfers from external accounts to EGMs, the system of the present disclosure dynamically determines which funding pathways are available for a given transaction and then employs an available funding pathway based on a preferential ranking or order of such available funding pathways. Such a configuration provides more flexibility in how users fund EGMs and offers a more efficient operation via customizing the funding options for each individual user based on one or more attributes of that individual user.

It should thus be appreciated that in certain embodiments of the present disclosure dynamically determine whether to transfer funds from an external account (e.g., a financial institution account) to a credit balance of an EGM in association with such funds being transferred to a gaming establishment account (and thus enables a gaming establishment better visibility into transactions involving users) or independent of such funds being transferred to any gaming establishment accounts (and thus saves users time and effort in having to set up such a gaming establishment account as well as save processing resources by reducing the quantity of accounts such funds have to travel to before reaching the destination device). In such embodiments, regardless of the funding pathway dynamically determined to employ, since certain gaming establishment patrons are uncomfortable venturing into a gaming establishment with large amounts of cash, the system enables a user access to an amount of funds transferred from an external account without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via the dynamically determined funding pathway involving a direct or indirect transfer of funds from an external account to an EGM, the system reduces or eliminates human errors which often occur when cash is distributed at gaming establishment interfaces, such as casino desks and/or cashless ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued cashless ticket voucher than the patron deserves) but also protects the gaming establishment (if the gaming establishment personnel inadvertently or fraudulently provides the patron a higher amount of cash and/or or a higher valued cashless ticket voucher than the patron deserves).

In certain embodiments, in association with the movement of funds from an external account to an EGM (and in view of the potential subsequent movement of such funds elsewhere), the system of the present disclosure imposes certain limits, such as responsible gaming limits and/or anti-money laundering limits, potentially not otherwise available. In certain such embodiments, since multiple funding pathways may be available to transfer funds from an external account and certain of such funding pathways include the transfer of funds from an external account that bypasses any gaming establishment fund management account maintained by a gaming establishment fund management system (that otherwise includes capabilities to screen for violations of certain limits), the system operates to track funds transferred over multiple funding pathways. In these embodiments, the system determines if any transactions, individually or collectively, violate one or more imposed limits, and takes zero, one or more appropriate actions accordingly. For example, since the transfer of funds from a financial institution account (i.e., an external account) to an EGM may occur independent of a cashless wagering account maintained by a cashless wagering system (that may impose funding limits), the system monitors events occurring in association with such funding pathways and enforces transfer limits on a periodic basis to ensure that responsible gambling limits are met and/or the system is not being abused to potentially launder money.

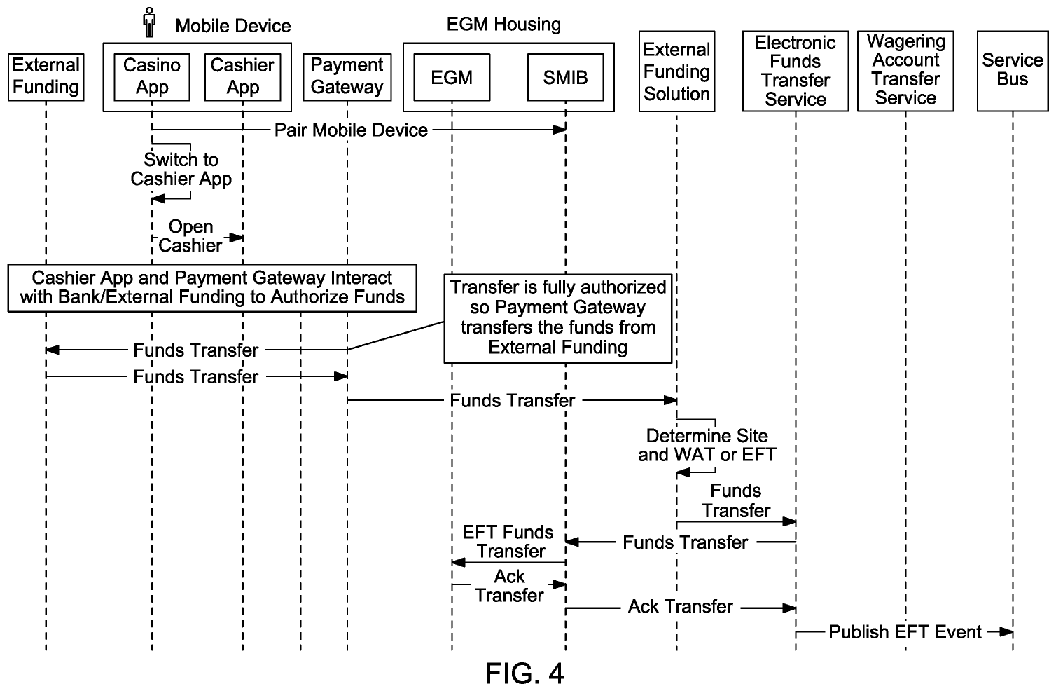

In certain embodiments, one or more components of one or more systems associated with the transfer of funds impose certain responsible gaming limitations and/or apply certain money laundering detections, such as detecting certain structured transactions. In these embodiments, since an available pathway employing electronic funds transfers includes the transfer of funds from an external account to an EGM without the involvement of any gaming establishment accounts and/or wagering account transfers (and thus creates potential money laundering risks), the system of the present disclosure imposes certain responsible gaming limits and/or detects certain potential money-laundering scenarios, and, if justified, takes certain actions. In these embodiments, as seen in FIG. 4, following the determination to employ a funding pathway including electronic funds transfers and following a transfer of funds from an external funding source to a credit balance of an EGM (which bypasses such funds being associated with any wagering account transfers), one or more servers that operate the electronic funds transfer service publish or otherwise report certain data associated with the external account transfer transaction to a service bus monitored by one or more servers operating as a responsible gaming and anti-money laundering service (as described above and seen in FIG. 1B).

In certain embodiments in which the system determines to utilize a funding pathway including electronic funds transfers, the system (e.g., one or more servers operating as a responsible gaming and anti-money laundering service) monitors events published to the service bus from the electronic funds transfer service and tracks instances of a user transferring funds from an external account to an EGM and then cashing out such funds to an instrument unaffiliated with a user, such as a cashless ticket voucher. In such embodiments, the system utilizes the tracked funds relative to an amount of transacting against such funds at the EGM (e.g., were the tracked funds utilized in association with at least a threshold amount of wagering activity) to potentially determine any money-laundering activities. For example, the system tracks the amount wagered from an electronic funds transfer in deposit when the user presses a cashout button and determines, based on that tracked data and the user's historical cashout information from previous electronic funds transfer deposits, if the user is a money laundering risk.

In certain embodiments in which the system determines to utilize a funding pathway including electronic funds transfers, the system (e.g., one or more servers operating as a responsible gaming and anti-money laundering service) monitors events published to the service bus from the electronic funds transfer service and tracks one or more sources of funds transferred to an EGM and situations in which the user cashed out such funds to an instrument unaffiliated with a user, such as a cashless ticket voucher. In such embodiments, the system utilizes the tracked sources of funds relative to an amount of transacting against such funds at the EGM to potentially determine any money-laundering activities. For example, the system determines, based on the source of funds, the amount of activity associated with such funds, historical sources of funds of the user and historical activities associated with such funds, if the user is a money laundering risk.

In certain embodiments in which the system determines to utilize a funding pathway including electronic funds transfers and further determines that the user's activity represents a potential money laundering risk, the system takes zero, one or more actions. In certain embodiments, the system prohibits the user from performing further deposits. In one such embodiment, the look back period for the evaluation of whether the user's activity represents a potential money laundering risk could be one time period (e.g., last 24 hours), while the limit or ban could be a different period (e.g., a week).

In certain embodiments in which the system determines to utilize a funding pathway including electronic funds transfers and further determines that the user's activity represents a potential money laundering risk, the system prohibits the user from performing further deposits until the user takes one or more actions. In one such embodiment, the system prompts the user to communicate with gaming establishment personnel (and/or a member of a payments team) to unlock the restrictions placed by the system on further deposits flagged as potential money laundering actions. In another such embodiment, the system prompts the user to enroll in a gaming establishment patron management system, such as enrolling to obtain a player tracking card, to potentially unlock (or modify) one or more restrictions associated with the user once the user is a known and registered user. In another such embodiment, the system prompts the user to participate in one or more know-your-customer checks to potentially unlock (or modify) one or more restrictions associated with the user once the user is a known and registered user. For example, the system tracks the cashless ticket vouchers that were cashed out by a user during a certain period of time, such as a single day, and specifically the total amount of funds cashed out to cashless ticket vouchers relative to an amount of funds of the cashless ticket voucher attributable to a previous electronic funds transfer deposit. In this example, upon the user's attempt to trigger another deposit of funds from an external account to an EGM (that occurs independent of any gaming establishment account), the system evaluates the amount of funds from such tracked electronic funds transfer deposits such that if the total amount of funds wagered for the day attributable to electronic funds transfer deposits divided by the total amount of electronic funds transfer deposits is below a threshold (which may be based on one or more factors, such as, but not limited to, an identity of the user, know-your-customer data associated with the user, a status of the user, any prior registration of the user, a ranking of the user in a gaming establishment patron management system), then the user may be prevented from triggering additional electronic funds transfer deposits.

In certain embodiments, in view of certain money laundering risks associated with a funding pathway including electronic funds transfers from an external account that bypass certain gaming establishment fund management accounts (and zero, one or more anti-money laundering protections associated with such gaming establishment fund management accounts), the system invokes certain limits to only permit one source of funding to be active at a given point in time. In one such embodiment, if a user deposits funds onto the EGM using a bill validator, the system disables other funding sources to prevent the mixing of funds obtained via an external account (i.e., the system prevents mixing of funds with the cash obtained via the bill validator). In another embodiment, if a user funds the EGM's credit meter via funds from an external account, the system disables other funding sources, such as the bill validator, until the user has left the EGM, or the EGM's credit meter has been reduced to a threshold amount, such as a zero balance.

In certain additional or alternative embodiments in which the system determines to utilize a funding pathway including electronic funds transfers, one or more components of the system reports on certain attempted and/or completed fund transactions from an external account. In one such embodiment, the system detects that a user has initiated a transfer (or a set of transfers) that at least reaches a regulatory reporting limit, and then the system notifies the operator that a regulatory report needs to be filed. Such an embodiment enables gaming establishment personnel the ability to have the appropriate information to file one or more suspicious activity reports with financial crimes regulatory agencies, such as the US Treasury's FinCEN. In another embodiment, the system facilitates the automatic filing of a regulatory report on behalf of the operator, such as automatically filling in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body. In another embodiment, the system denies any automatic approval (such as one set up by a user) of an attempted transfer due to the transfer at least reaching a regulatory and/or operational control limit, and the system requires manual approval by gaming establishment personnel (and/or personnel of one or more financial institutions involved in the transfer transaction).

In certain embodiments in which the system determines to utilize a funding pathway including electronic funds transfers, the system (e.g., one or more servers operating as a responsible gaming and anti-money laundering service) additionally or alternatively monitors events published to the service bus from the electronic funds transfer service and imposes certain deposit limits in association with funds transferred from an external account independent of any gaming establishment account (and the deposit limits associated with such gaming establishment accounts). That is, while certain jurisdictions supports various types of limits on funds associated with gaming establishment accounts (e.g., certain Nevada regulations require deposit limits on each instrument used to fund an account and other Nevada regulations require a cashless wagering account to enable a user to set a deposit limit over a desired period of time), such limits associated with gaming establishment accounts are different from limits associated with external accounts, such as financial institution accounts. Accordingly, if the funding of an EGM from an external account utilizes a funding pathway employing electronic funds transfers that bypasses the employment of any gaming establishment fund management accounts of a user, such as a cashless wagering account, then the system of the present disclosure will implement certain required limits (i.e., usage controls) because the gaming establishment fund management account, such as the cashless wagering account, is not otherwise exposed to the funding/deposit operations. In different embodiments, these limits are applicable per external account, per payment instrument (e.g., per debit card associated with one or more external accounts), per unit of time (e.g., a daily deposit limit) and/or per transaction.

In certain embodiments in which the system determines to utilize a funding pathway including electronic funds transfers, the system implements one or more transfer limits, usage controls and/or security measures. In these embodiments, one or more components of the system (e.g., one or more servers operating as a responsible gaming and anti-money laundering service) are tasked with monitoring activity associated with one or more external accounts used to transfer funds to a gaming establishment device independent of any gaming establishment fund management accounts and accepting or rejecting such activity based on the currently configured limits associated with the external account relative to certain prior activity, if any, during an applicable period of time. In such embodiments, based on the compliance (or lack thereof) of one or more deposit limits imposed on funds transferred from the external account, such components of the system notifies the user of a status of the attempted deposit of funds to the EGM via a message displayed at any suitable device, via an email, via an SMS or text message, and/or via a notification displayed by a mobile device application.

In certain embodiments in which the system determines to utilize a funding pathway including electronic funds transfers, the system sets one or more limits per user and/or per payment instrument employed. In certain embodiments, the system enables one or more users to set one or more limits for that user. In certain of these embodiments, the system utilizes one or more attributes of the user, such as if the user is associated with an account maintained by a gaming establishment patron management system (e.g., a player tracking account), and/or a status of any account maintained by a gaming establishment patron management system (e.g., a player tracking account status), in determining whether to enable the user to set one or more usage controls and/or security measures in association with that user.

In certain embodiments in which the system determines to utilize a funding pathway including electronic funds transfers, in applying one or more transfer limit compliance determinations, the system employs the same limits per user and/or per payment instrument employed. In certain embodiments, in applying one or more transfer limit compliance determinations, the system employs different limits per user and/or per payment instrument employed. In certain such embodiments, the system applies varying limits depending upon who the user is and what levels of know-your-customer checks have been performed. In certain embodiments in which the system determines to utilize a funding pathway including electronic funds transfers, the system applies varying limits depending upon the user having one or more accounts associated with the gaming establishment, such as the user having a player's club account. In certain additional embodiments, the system employs multiple factors in determining the limits to impose on attempted transfers from external accounts that occur independent of any gaming establishment account or wagering account transfers. In such embodiments, these factors include, but are not limited to, one or more of an anticipated spend of a user, a historic spend of a user and/or one or more balances associated with that user, an amount of funds transferred from an external account, a timing of funds transferred from the external account, an external funding source which maintains the external account, historical transfers from the external account, historical transfers from the external funding source and/or the type of funding pathway employed.

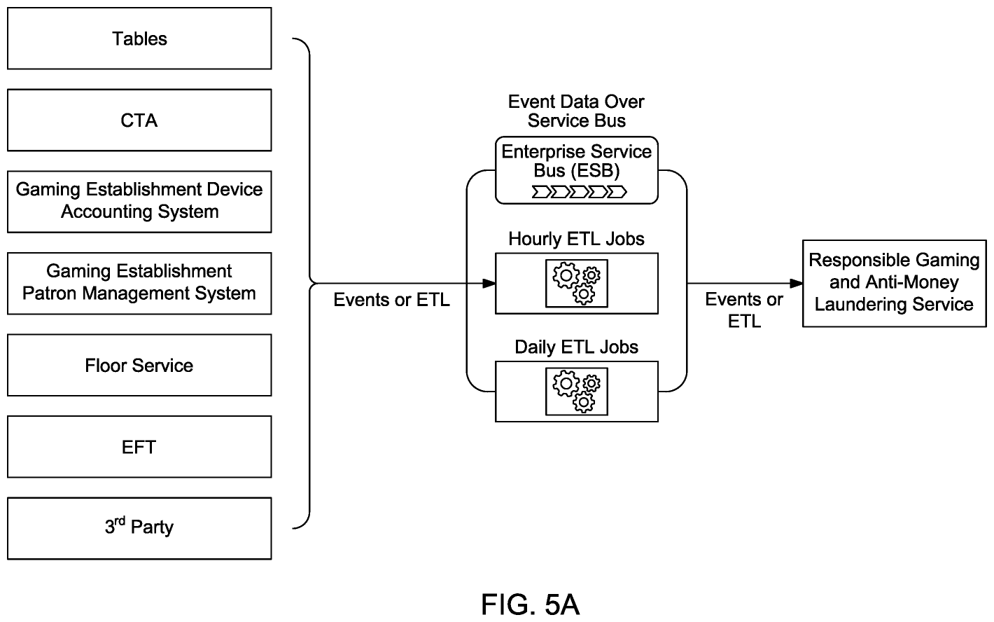

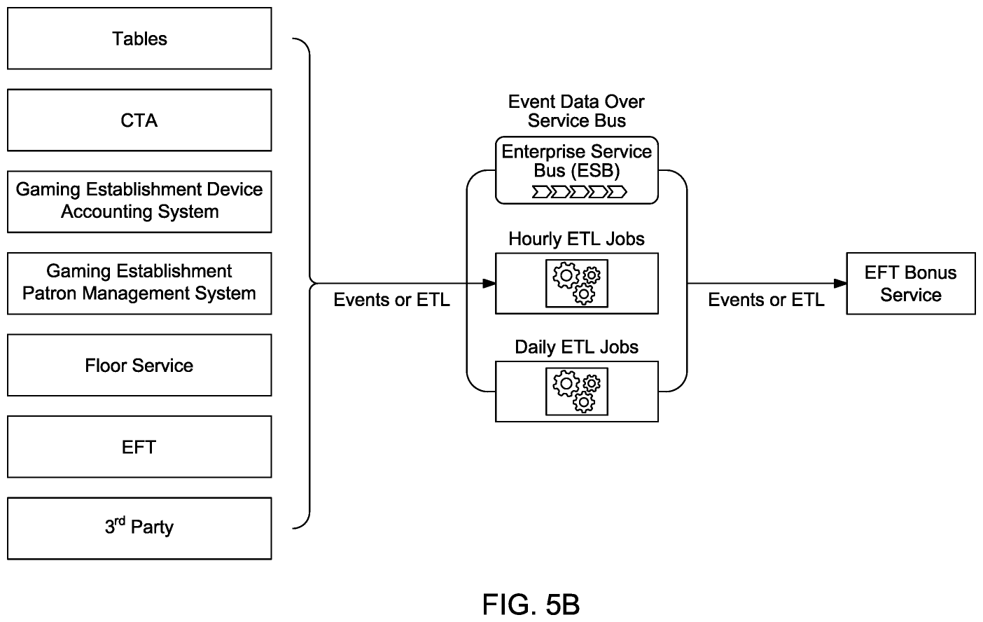

It should be appreciated that in certain embodiments in which the system determines to utilize a funding pathway including electronic funds transfers to impose certain responsible gaming limitations and/or apply certain anti-money laundering actions, the system (e.g., one or more servers operating as a responsible gaming and anti-money laundering service) receives events and data from the electronic funds transfer service as well as other components of the system (and/or components distinct from the system but operating with the system). In these embodiments, to properly analyze a transfer along a funding pathway employing electronic funds transfers in the context of the user's activity, the system (e.g., one or more servers operating as a responsible gaming and anti-money laundering service) accesses one or more additional sources of gaming establishment data, including, but not limited to, user session data, meter movements on EGMs, events that occur on EGMs, and/or events that occur independent of any EGMs. For example, as seen in FIG. 5A, data associated with various events occurring in association with various components is reported to a service bus and one or more servers operating as a responsible gaming and anti-money laundering service utilizes part or all of such event data to determine to impose certain responsible gaming limitations and/or apply certain anti-money laundering actions. In this example, with multiple channels of data to review, the system can properly gauge a user's activity and automatically alert gaming establishment personnel of suspicious activity (or enable gaming establishment personnel to view such activity and manually raise one or more alarms regarding any suspicious activity).

Accordingly, the system of the present disclosure provides an alternative, non-cash-based and non-ticket voucher-based option for a gaming establishment patron to transfer, with or without the employment of any gaming establishment accounts, funds to an EGM while complying with various anti-money laundering regulations and/or responsible gambling limitations which require the tracking of certain financial transactions associated with a gaming establishment patron.

In certain embodiments, in association with the movement of funds from an external account to an EGM, the system of the present disclosure triggers certain bonuses based on the potential prioritization of certain funding pathways over other funding pathways. In certain such embodiments, since multiple funding pathways may be available to transfer funds from an external account and certain of such funding pathways are preferable over others, such as because such funding pathways pertain to an identified user having a cashless wagering account over an unidentified user (or an identified user without a cashless wagering account) and/or such funding pathways are associated with different fee structures and/or amounts of time to complete, the system operates to potentially offer one or more bonuses in association with certain funding pathways. In these embodiments, the system determines if any transactions, individually or collectively, warrant a bonus event and if so, causes one or more bonus events to occur.

In certain embodiments, one or more components of one or more systems associated with the transfer of funds offer certain bonus event opportunities based, at least in part, on the funding pathway determined to employ. In these embodiments, since an available pathway employing electronic funds transfers includes the transfer of funds from an external account to an EGM without identifying, to the gaming establishment, the user, the system of the present disclosure utilizes certain bonus event opportunities to potentially convert an anonymous user to a known user (e.g., a user having an account maintained by a gaming establishment patron management system and/or an account maintained by a gaming establishment fund management system). In these embodiments, as seen in FIG. 4, following the determination to employ a funding pathway including electronic funds transfers and following a transfer of funds from an external funding source to a credit balance of an EGM (which bypasses such funds being associated with any wagering account transfers), one or more servers that operate the electronic funds transfer service publish or otherwise report certain data associated with the external account transfer transaction to a service bus monitored by one or more servers operating as an electronic funds transfer bonus server (as described above and seen in FIG. 1C).

In certain embodiments in which the system determines to utilize a funding pathway including electronic funds transfers, the system (e.g., one or more servers operating as an electronic funds transfer bonus service) monitors events published to the service bus from the electronic funds transfer service and determines whether or not to offer one or more bonus events. In such embodiments, the system (e.g., one or more servers operating as an electronic funds transfer bonus service) determines, based on the electronic funds transfer event including but not limited to, the amount of the transfer, and/or the date and time of the transfer, whether or not to bonus the user. In these embodiments, if the system determines to trigger one or more bonuses, such a bonus is delivered directly to the EGM (via the gaming establishment floor management system) or delivered to the gaming establishment patron management system (i.e., for an electronic funds transfer funding pathway used for an identified user (e.g., a carded player) whom does not have a cashless wagering account or other gaming establishment account associated with wagering account transfer capabilities).

In certain embodiments, if the system (e.g., one or more servers operating as an electronic funds transfer bonus service) determines to trigger a bonus event in association with the transfer of funds from the external account, the system determines one or more parameters of the bonus event. Such parameters establish how the bonus event will be provided, what the bonus event will entail and any other features or functionality of the bonus event.

In certain embodiments, a parameter of the bonus event includes an amount of funds. In certain such embodiments, the amount of funds to associate with a bonus event includes a static award, such as a static amount of credits, a static quantity of player tracking points, a static player tracking point modifier applicable to a quantity of player tracking points subsequently earned by the user, a static player tracking point modifier applicable to a quantity of player tracking points previously earned by the user, a static quantity of non-cashable promotional credits usable to fund one or more plays of one or more games of chance, a static quantity of virtual credits usable for a play of a social or non-wagering game and/or a static discount from the price of a good and/or service offered by (or otherwise associated with) a gaming establishment.

In certain embodiments, the system randomly determines the amount of funds to associate with the bonus event. In certain such embodiments, the randomly determined amount of funds is selected from a predetermined range of amounts. In certain embodiments, the determined amount of funds is based on the amount of funds transferred from the external account. In one such embodiment, the determined amount of funds is a percentage of the amount of funds transferred from the external account. In another such embodiment, the determined amount of funds is an amount selected based on the amount of funds transferred from the external account.

In certain embodiments, the amount of funds available in association with the transfer from the external account includes a variable award, such as a variable amount of credits, a variable quantity of player tracking points, a variable player tracking point modifier applicable to a quantity of player tracking points subsequently earned by the user, a variable player tracking point modifier applicable to a quantity of player tracking points previously earned by the user, a variable quantity of non-cashable promotional credits usable to fund one or more plays of one or more games of chance, a variable quantity of virtual credits usable for a play of a social or non-wagering game, and/or a variable discount from the price of a good and/or service offered by (or otherwise associated with) a gaming establishment. In certain such embodiments, the variable award is determined based on the results of one or more games of chance (or games of skill) including, but not limited to: a play of any suitable slot game; a play of any suitable wheel game; a play of any suitable card game (including any suitable type of poker game, such as, but not limited to, a multiple hand poker game, Texas Hold'em, Omaha, Three Card Poker, Four Card Poker, Seven Card Stud, Pai Gow Poker, Caribbean Stud Poker, or Let It Ride Poker, as well as other suitable non-poker interactive cards games, such as, but not limited to, blackjack, Baccarat, Spanish 21, Casino War, Super Fun 21, or Vegas Three Card Rummy), a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable stacked wilds game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable skill game; a play of any suitable auction game; a play of any suitable reverse-auction game; a play of any suitable group game; a play of any suitable game in a service window of an EGM; a play of any suitable game on a mobile device; and/or a play of any suitable game of the present disclosure.

In certain embodiments, alternative from (or in addition to) determining an amount of funds for the bonus event realized in association with a transfer from an external account, the system determines one or more features to activate in association with the bonus event, such as to activate for one or more plays of a game occurring at the EGM where the funds from the external account are transferred to. In these embodiments, the features to activate and/or the magnitude of such features is based on one or more of the above-described factors for determining the amount of funds. In certain embodiments, the system selects the same feature for each bonus event with the magnitude of the feature changing from bonus event to bonus event. In certain embodiments, the system selects different features for two or more bonus events. In certain embodiments, different features have the same probability of being selected. In certain embodiments, different features have different probabilities of being selected.

In different embodiments, the selected features associated with the bonus event include any feature that results in a modification of one or more components, aspects, or elements of one or more plays of a game, such as the modification of one or more game outcomes of one or more plays of a game (e.g., the symbols evaluated for the play(s) of the game), the modification of the paytable utilized for one or more plays of the game and/or the modification of any award determined for one or more plays of the game. In such different embodiments, the selected features include, but are not limited to: a feature which superimposed one or more symbols over the randomly generated symbols of the reels; a feature which replaces one or more symbols of the randomly generated symbols of the reels with a predetermined symbol pattern; a feature which replaces one or more symbols of the randomly generated symbols of the reels with a predetermined pattern of wild symbols; a modifier, such as a multiplier, feature; a book-end wild symbols feature; a stacked wild symbols feature; an expanding wild symbols feature; a nudging wild symbols feature; a feature modifying a quantity of wild symbols available to be generated; a retrigger symbol feature; an anti-terminator symbol feature; a locking reel feature; an expanding reel feature; a locking symbol position feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying an activation of a reel (or a designated reel); a feature modifying an activation of a plurality of reels; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying an amount of free spins provided; a feature modifying a game terminating or ending bonus event condition; a feature modifying how one or more aspects of one or more games (e.g., colors, speeds, sound) are displayed; and/or a feature modifying any game play feature associated with any play of any game of the present disclosure.

In certain embodiments, if the user associated with the external account does not have a gaming establishment patron management system account, then the system delivers the award for the bonus event to the EGM where the funds from the external account are transferred to. In these embodiments, if the user associated with the external account has a gaming establishment patron management system account, then the system determines to deliver the award for the bonus event to the user at the EGM where the funds from the external account are transferred to or as a credit to one or more balances associated with such a gaming establishment patron management system account.

In certain embodiments, in addition to (or alternative from) delivering the bonus event to a user based on if the user associated with the external account has or does not have a gaming establishment patron management system account, the system delivers the bonus event to a user via one or more cashless ticket vouchers. In these embodiments, the system delivers to a user, in physical form (e.g., paper) or virtual form (e.g., data communicated to a mobile device of the user), a cashless ticket voucher associated with the award determined for the bonus event. In these embodiments, following a subsequent redemption of the cashless ticket voucher associated with the award determined for the bonus event at the same (or a different) EGM, the system delivers the determined award.

It should be appreciated that in certain embodiments in which the system determines to utilize a funding pathway including electronic funds transfers to offer certain bonus events, the system (e.g., one or more servers operating as an electronic funds transfer bonus service) receives events and data from the electronic funds transfer service as well as other components of the system (and/or components distinct from the system but operating with the system). In these embodiments, to properly analyze a transfer along a funding pathway employing electronic funds transfers in the context of the user's activity, the system (e.g., one or more servers operating as an electronic funds transfer bonus service) accesses one or more additional sources of gaming establishment data, including, but not limited to, user session data, meter movements on EGMs, events that occur on EGMs, and/or events that occur independent of any EGMs. For example, as seen in FIG. 5B, data associated with various events occurring in association with various components is reported to a service bus and one or more servers operating as an electronic funds transfer bonus service utilizes part or all of such event data to determine to zero, one or more bonus events to deliver to a user associated with the external account. In this example, with multiple channels of data to review, the system can properly gauge a user's activity and more effectively design and implement promotions and bonus events tailored to that particular user.

It should be appreciated that the funding pathways employed to transfer electronic fund data of the present disclosure may occur in addition to or as an alternative from cash-based fund transfers and/or cashless ticket voucher-based fund transfers. It should be further appreciated that any functionality or process of the present disclosure may be implemented via one or more servers (associated with or independent of any component of any system disclosed herein), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of the system (e.g., a payment gateway, an external funding solution, an electronic funds transfer service, a responsible gaming and anti-money laundering service and/or an electronic funds transfer bonus service); zero, one or more components of a financial institution that maintains an external account; zero, one or more components of a gaming establishment system (e.g., a gaming establishment patron management system, a gaming establishment device management system, and/or a gaming establishment accounting system) and/or zero, one or more gaming establishment devices. In these embodiments, such components of the component of the system, the component of the financial institution that maintains the external account, the component of the gaming establishment system, and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the system, the component of the financial institution that maintains the external account, the component of the gaming establishment system, and/or the gaming establishment device; (3) accessing memory to configure or reconfigure parameters in the memory according to indicia read from the component of the system, the component of the financial institution that maintains the external account, the component of the gaming establishment system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the system (e.g., a payment gateway, an external funding solution, an electronic funds transfer service, a responsible gaming and anti-money laundering service and/or an electronic funds transfer bonus service), the component of the financial institution that maintains the external account, the component of the gaming establishment system, and/or the gaming establishment device, while in other embodiments, at least one component of the controller resides outside of the housing of the component of the system, the component of the financial institution that maintains the external account, the component of the gaming establishment system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the system, the component of the financial institution that maintains the external account, the component of the gaming establishment system, and/or the gaming establishment device disclosed herein. In certain embodiments, the at least one memory device resides within the housing of the component of the system, the component of the financial institution that maintains the external account, the component of the gaming establishment system, and/or the gaming establishment device, while in other embodiments at least one component of the at least one memory device resides outside of the housing of the component of the system, the component of the financial institution that maintains the external account, the component of the gaming establishment system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the system, the component of the financial institution that maintains the external account, the component of the gaming establishment system, and/or the gaming establishment device; (2) associations between configuration indicia read from the component of the system, the component of the financial institution that maintains the external account, the component of the gaming establishment system, and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the system, the component of the financial institution that maintains the external account, the component of the gaming establishment system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the system (e.g., a payment gateway, an external funding solution, an electronic funds transfer service, a responsible gaming and anti-money laundering service and/or an electronic funds transfer bonus service), the component of the financial institution that maintains the external account, the component of the gaming establishment system, and/or the gaming establishment device to control the component of the system, the component of the financial institution that maintains the external account, the component of the gaming establishment system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the system, the component of the financial institution that maintains the external account, the component of the gaming establishment system, and/or the gaming establishment device through any suitable data network described above (such as an Internet or intranet).

The at least one memory device also stores a plurality of device drivers. Examples of different types of device drivers include device drivers for the component of the system, the component of the financial institution that maintains the external account, the component of the gaming establishment system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the system, the component of the financial institution that maintains the external account, the component of the gaming establishment system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the system, the component of the financial institution that maintains the external account, the component of the gaming establishment system, and/or the gaming establishment device loads the new device driver from the at least one memory device to enable communication with the new device. For instance, one type of card reader in the component of the system, the component of the financial institution that maintains the external account, the component of the gaming establishment system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the system, the component of the financial institution that maintains the external account, the component of the gaming establishment system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the system, the component of the financial institution that maintains the external account, the component of the gaming establishment system, and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the system (e.g., a payment gateway, an external funding solution, an electronic funds transfer service, a responsible gaming and anti-money laundering service and/or an electronic funds transfer bonus service), the component of the financial institution that maintains the external account, the component of the gaming establishment system, and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the system, the component of the financial institution that maintains the external account, the component of the gaming establishment system, and/or the gaming establishment device operator to, when actuated, cause the component of the system, the component of the financial institution that maintains the external account, the component of the gaming establishment system, and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the system, the component of the financial institution that maintains the external account, the component of the gaming establishment system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the system, the component of the financial institution that maintains the external account, the component of the gaming establishment system, and/or the gaming establishment device, such as one or more rechargeable power sources (e.g., rechargeable batteries) located at the component of the system, the component of the financial institution that maintains the external account, the component of the gaming establishment system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the system, the component of the financial institution that maintains the external account, the component of the gaming establishment system, and/or the gaming establishment device; detecting the presence and/or identity of various persons (e.g., users, casino employees, etc.), devices (e.g., user input devices), and/or systems within a predetermined proximity to the component of the system, the component of the financial institution that maintains the external account, the component of the gaming establishment system, and/or the gaming establishment device.

The at least one data preservation component is configured to detect or sense one or more events and/or conditions that, for example, may result in damage to the component of the system, the component of the financial institution that maintains the external account, the component of the gaming establishment system, and/or the gaming establishment device and/or that may result in loss of information associated with the component of the system, the component of the financial institution that maintains the external account, the component of the gaming establishment system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the system, the component of the financial institution that maintains the external account, the component of the gaming establishment system, and/or the gaming establishment device to operate in a mobile environment.

The at least one geolocation module is configured to acquire geolocation information from one or more remote sources and use the acquired geolocation information to determine information relating to a relative and/or absolute position of the component of the system, the component of the financial institution that maintains the external account, the component of the gaming establishment system, and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the system (e.g., a payment gateway, an external funding solution, an electronic funds transfer service, a responsible gaming and anti-money laundering service and/or an electronic funds transfer bonus service), the component of the financial institution that maintains the external account, the component of the gaming establishment system, and/or the gaming establishment device. For example, in one embodiment, the current user is required to perform a login process at the component of the system, the component of the financial institution that maintains the external account, the component of the gaming establishment system, and/or the gaming establishment device in order to access one or more features. Alternatively, the component of the system, the component of the financial institution that maintains the external account, the component of the gaming establishment system, and/or the gaming establishment device is configured to automatically determine the identity of the current user based on one or more external signals, such as an RFID tag or badge worn by the current user and that provides a wireless signal to the component of the system, the component of the financial institution that maintains the external account, the component of the gaming establishment system, and/or the gaming establishment device that is used to determine the identity of the current user. In at least one embodiment, various security features are incorporated into the component of the system, the component of the financial institution that maintains the external account, the component of the gaming establishment system, and/or the gaming establishment device to prevent unauthorized users from accessing confidential or sensitive information.

The at least one information filtering module is configured to perform filtering (e.g., based on specified criteria) of selected information to be displayed at one or more displays of the component of the system, the component of the financial institution that maintains the external account, the component of the gaming establishment system, and/or the gaming establishment device.

In various embodiments, the component of the system, the component of the financial institution that maintains the external account, the component of the gaming establishment system, and/or the gaming establishment device includes a plurality of communication ports configured to enable the at least one processor of the component of the system, the component of the financial institution that maintains the external account, the component of the gaming establishment system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the system, the component of the financial institution that maintains the external account, the component of the gaming establishment system, and/or the gaming establishment device has a support structure, housing, or cabinet that provides support for a plurality of the input devices and the output devices of the component of the system, the component of the financial institution that maintains the external account, the component of the gaming establishment system, and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to a receipt of data associated with an approval of an amount of funds transferred from a financial institution account maintained, independent of any gaming establishment, in association with a financial institution, cause the processor to:
responsive to a determination that a user associated with the financial institution account is associated with a gaming establishment account maintained by a gaming establishment fund management system, activate a wagering account transfer funding pathway comprising:
causing a first transfer of the amount of funds to the gaming establishment account, and
causing a second transfer of the amount of funds from the gaming establishment account to a balance of a gaming establishment device, and
responsive to a determination that the user associated with the financial institution account is not associated with any gaming establishment accounts maintained by the gaming establishment fund management system, activate an electronic funds transfer funding pathway comprising causing, independent of any wagering account transfers associated with the gaming establishment device, a transfer of the amount of funds to the balance of the gaming establishment device.

2. The system of claim 1, wherein the memory device stores a plurality of further instructions that, when executed by the processor responsive to a determination that the user associated with the financial institution account is not associated with a gaming establishment patron management system account, cause the processor to activate the electronic funds transfer funding pathway.

3. The system of claim 2, wherein the activation of the electronic funds transfer funding pathway occurs responsive to the determination that the user associated with the financial institution account is not associated with a gaming establishment patron management system account prior to any determination that the user associated with the financial institution account is associated with any gaming establishment account.

4. The system of claim 1, wherein the memory device stores a plurality of further instructions that, when executed by the processor, cause the processor to publish data associated with the transfer of funds to the balance of the gaming establishment device to a service bus.

5. The system of claim 1, wherein the wagering account transfer funding pathway and the electronic funds transfer funding pathway are associated with different external funding instruments to access different financial institution accounts.

6. The system of claim 1, wherein the wagering account transfer funding pathway is associated with a first tracked meter of the gaming establishment device and the electronic funds transfer funding pathway is associated with a second, different tracked meter of the gaming establishment device.

7. The system of claim 1, wherein the wagering account transfer funding pathway is associated with a first fee and the electronic funds transfer funding pathway is associated with a second, different fee.

8. The system of claim 1, wherein the gaming establishment account comprises a cashless wagering account.

9. The system of claim 1, wherein the gaming establishment device comprises an electronic gaming machine.

10. A system comprising:
a processor; and
a memory device that stores a plurality of instructions that, when executed by the processor responsive to a receipt of data associated with an approval of an amount of funds transferred from a financial institution account maintained, independent of any gaming establishment, in association with a financial institution, cause the processor to:
responsive to a determination that a user associated with the financial institution account is not associated with any gaming establishment patron management account maintained by a gaming establishment patron management system, activate an electronic funds transfer funding pathway comprising a direct transfer of the amount of funds to a credit balance of an electronic gaming machine, the direct transfer occurring independent of any gaming establishment account maintained by a gaming establishment fund management system, and
responsive to a determination that the user associated with the financial institution account is associated with a gaming establishment patron management account maintained by the gaming establishment patron management system and responsive to a determination that the user associated with the financial institution account is associated with a gaming establishment account maintained by the gaming establishment fund management system, activate a wagering account transfer funding pathway comprising an indirect transfer of the amount of funds to the credit balance of the electronic gaming machine, the indirect transfer occurring in association with the gaming establishment account maintained by the gaming establishment fund management system.

11. The system of claim 10, wherein the direct transfer is associated with increasing a first meter of the electronic gaming machine and the indirect transfer is associated with increasing a second, different meter of the electronic gaming machine.

12. A method of operating a system, the method comprising:
responsive to a receipt of data associated with an approval of an amount of funds transferred from a financial institution account maintained, independent of any gaming establishment, in association with a financial institution and responsive to a determination that a user associated with the financial institution account is associated with a gaming establishment account maintained by a gaming establishment fund management system, activating, by a processor, a wagering account transfer funding pathway comprising:
causing a first transfer of the amount of funds to the gaming establishment account, and
causing a second transfer of the amount of funds from the gaming establishment account to a balance of a gaming establishment device, and
responsive to the receipt of data associated with the approval of the amount of funds transferred from the financial institution account and responsive to a determination that the user associated with the financial institution account is not associated with any gaming establishment accounts maintained by the gaming establishment fund management system, activating, by the processor, an electronic funds transfer funding pathway comprising causing, independent of any wagering account transfers associated with the gaming establishment device, a transfer of the amount of funds to the balance of the gaming establishment device.

13. The method of claim 12, further comprising, responsive to the receipt of data associated with the approval of the amount of funds transferred from the financial institution account and responsive to a determination that the user associated with the financial institution account is not associated with a gaming establishment patron management system account, activating, by the processor, the electronic funds transfer funding pathway.

14. The method of claim 13, wherein the activation of the electronic funds transfer funding pathway occurs responsive to the determination that the user associated with the financial institution account is not associated with a gaming establishment patron management system account prior to any determination that the user associated with the financial institution account is associated with any gaming establishment account.

15. The method of claim 12, further comprising publishing, by the processor, data associated with the transfer of funds to the balance of the gaming establishment device to a service bus.

16. The method of claim 12, wherein the wagering account transfer funding pathway and the electronic funds transfer funding pathway are associated with different external funding instruments to access different financial institution accounts.

17. The method of claim 12, wherein the wagering account transfer funding pathway is associated with a first tracked meter of the gaming establishment device and the electronic funds transfer funding pathway is associated with a second, different tracked meter of the gaming establishment device.

18. The method of claim 12, wherein the wagering account transfer funding pathway is associated with a first fee and the electronic funds transfer funding pathway is associated with a second, different fee.

19. The method of claim 12, wherein the gaming establishment account comprises a cashless wagering account.

20. The method of claim 12, wherein the gaming establishment device comprises an electronic gaming machine.
